(19) United States
(12) Patent Application Publication
(10) Pub. No.: US 2012/0139813 A1
(43) Pub. Date: Jun. 7, 2012

(54) WIRELESS DEVICE PROVIDING OPERABILITY FOR BROADCAST STANDARDS AND METHOD ENABLING SUCH OPERABILITY

(76) Inventors: Jaume Anguera, Vinaros (ES); Carmen Borja, Barcelona (ES); Cristina Picher, Sabadell (ES); Aurora Andujar, Rubi (ES)

(21) Appl. No.: 13/378,588

(22) PCT Filed: Jun. 17, 2010
(86) PCT No.: PCT/EP10/03645

§ 371 Date: Jan. 25, 2012

Related U.S. Application Data
(60) Provisional application No. 61/220,371, filed on Jun. 25, 2009.
(60) Provisional application No. 61/218,522, filed on Jun. 19, 2009.

(30) Foreign Application Priority Data
Jun. 18, 2009 (EP) 09163057.4
Apr. 21, 2010 (ES) P201000508

(51) Int. Cl. H01Q 5/00

(52) U.S. Cl. 343/858

(57) ABSTRACT

The invention refer to a wireless handheld or portable device including an antenna system (250) capable of operation in a first frequency region and in a second frequency region, wherein the highest frequency of the second frequency region is lower than the lowest frequency of the first frequency region, the antenna system (250) comprising an antenna structure (260) including: an antenna element (251) having a first connection point (253a) and a second connection point (253b); a ground plane layer (202) having at least one connection point (204); a first internal port (261), said first port being defined between the first connection point (253a) of the antenna element (251) and one of the at least one connection point (204) of the ground plane layer (202); and a second internal port (262), said second port (262) being defined between the second connection point (253b) of the antenna element (251) and one of the at least one connection point (204) of the ground plane layer (202); the antenna system further comprising a first external port (231) for coupling electromagnetic wave signals in the first frequency region, a second external port (232) for coupling electromagnetic wave signals in the second frequency region, and a radiofrequency system (270) operatively connected between the first and second internal ports (261, 262) of the antenna structure (260) and the first and second external ports (231, 232) of the antenna system (250); wherein the input impedance of the antenna structure (260) at each of the first and second internal ports (261, 262) when disconnected from the radiofrequency system (270) features an imaginary part not equal to zero for any frequency of the second frequency region, so that the antenna structure (260) is not resonant for any frequency of the second frequency region; wherein the radiofrequency system (270) comprises a frequency-selective circuit (301) arranged so as to effectively short-circuit the second internal port (262) for the frequencies of the first frequency region but not for the frequencies of the second frequency region, to operatively connect the second external port (232) to one of the first and the second internal ports (261, 262) for the frequencies of the second frequency region but not for the frequencies of the first frequency region, and to operatively connect the first external port (231) to the first internal port (261) for the frequencies of the first frequency region. Further the invention refers to a corresponding method and a similar device and a further method corresponding to the similar device.

### OBJECT OF THE INVENTION

The present invention relates to the field of wireless handheld devices, and generally to wireless portable devices (such as for instance but not limited to a mobile phone, a smartphone, a PDA, an MP3 player, a headset, a USB dongle, a laptop computer, a gaming device, a digital camera, a PCMCIA or Cardbus 32 card, or generally a multifunction wireless device).

It is an object of the present invention to provide a wireless handheld or portable device which is capable of transmitting and receiving electromagnetic wave signals corresponding to one or more cellular communication standards (such as for example GSM 900, GSM 1800 or UMTS) or wireless connectivity standards (e.g., WiFi) and, at the same time, capable of receiving electromagnetic wave signals corresponding to one or more broadcast audio and/or video standards (such as for instance FM, DVB-H or DMB). A wireless device according to the present invention advantageously provides both types of standards (i.e., cellular communication and/or wireless connectivity standards, and broadcast standards) without necessarily resulting in an increase of its size with respect to another wireless device not providing any broadcast standard.

Another object of the invention relates to a method to provide operability in one or more broadcast audio and/or video standards to an existing wireless handheld or portable device already operating one or more cellular communication standards and/or wireless connectivity standards, without necessarily requiring an increase in the size of the wireless device. Such a method can be easily performed on virtually any wireless handheld or portable device without requiring major changes in the design of said existing wireless device.

### BACKGROUND OF THE INVENTION

Wireless handheld or portable devices typically operate one or more cellular communication standards (such as for example GSM 850, GSM 900, GSM 1800, GSM 1900, UMTS, HSDPA, CDMA, W-CDMA, LTE, CDMA2000, TD-SCDMA, etc.) and/or wireless connectivity standards (such as for instance WiFi, IEEE802.11 standards, Bluetooth, ZigBee, UWB, WiMAX, WiBro, or other high-speed standards), each standard being allocated in one or more frequency bands, and said frequency bands being contained within one or more regions of the electromagnetic spectrum. For example, most mobile cellular communication standards are allocated within frequency regions between 800 MHz and 2200 MHz. Wireless connectivity standards may be allocated within frequency regions even above 2200 MHz.

For that purpose, a space within the wireless handheld or portable device is usually dedicated to the integration of an antenna system, so that the antenna system is fully contained inside the wireless device (such antenna systems usually being referred to as internal antenna systems). The antenna system is, however, expected to be small in order to occupy as little space as possible within the device, which then allows for smaller devices, or for the addition of more specific equipment and functionality into the device.

An antenna system for a wireless device typically includes an antenna element operating in combination with a ground plane layer to provide a certain radioelectric performance (such as for example in terms of input impedance level, impedance bandwidth, gain, efficiency, or radiation pattern) in one or more frequency regions of the electromagnetic spectrum.

Moreover, the integration of the antenna system within the wireless handheld device must be done correctly so as to ensure that the wireless device itself attains a satisfactory radioelectric performance (such as for example in terms of radiated power, received power, or sensitivity).

For a good wireless connection, high gain and efficiency and good input impedance matching to a reference impedance of 50 Ohms are usually required. For that reason, typically the antenna element has a dimension close to an integer multiple of a quarter of the wavelength at a frequency of operation of the antenna element, so that the antenna element is at resonance at said frequency and a radiation mode can be properly excited on said antenna element.

Such an antenna system is usually very efficient at the resonance frequency of the antenna element and maintains a similar performance within a frequency range defined around said resonance frequency (or resonance frequencies). However, outside said frequency range (referred to as bandwidth) the efficiency and other relevant antenna parameters deteriorate with an increasing distance to said resonance frequency.

In some cases, the antenna element is short-circuited to the ground plane layer in order to better adjust the input impedance level around the resonance frequency (or resonance frequencies).

Typical prior-art internal antenna systems for wireless handheld or portable devices based on antenna elements operating at resonance feature a 5-15% bandwidth. Thus, said antenna systems are operative within a frequency region which may be sufficient to contain the frequency bands of, for example, most of the mobile cellular communication standards such as GSM900, GSM1800, UMTS, etc.

There is a trend to include more and more multimedia functionality into wireless handheld or portable devices, and in particular to add the capability of receiving electromagnetic wave signals corresponding to one or more broadcast audio and/or video standards (such as FM, DVB-H or DMB).

These and other broadcast standards operate in frequency bands typically allocated in regions of the electromagnetic spectrum at frequencies much lower than those of the regions used by the cellular communication and wireless connectivity standards, such as for example FM (operating in the band of 88-108 MHz) or DVB-H (operating in the bands of 470-702 MHz, or 470-770 MHz).

Moreover, these frequency bands extend over a wide bandwidth. For instance, the FM standard uses a frequency band from 88 MHz to 108 MHz, which implies a relative bandwidth of approximately a 20% with respect to the center frequency of said frequency band. Similarly, the DVB-H service in Europe should cover a bandwidth including the 470-770 MHz frequency band (UHF), which is equivalent to a relative bandwidth of approximately 50% with respect to the center frequency of said frequency band.

Some prior-art wireless handheld or portable devices that integrate a broadcast standard include an additional antenna system comprising a resonant antenna element.

However, such resonant antenna elements are inherently large in size due to the low frequencies (or equivalently long wavelengths) at which these broadcast standards operate.

To make matters worse, the wide frequency bandwidth in which the antenna element must operate in order to cover the entire frequency band of the broadcast standard makes it difficult, or even impossible, to reduce the size of said antenna element, since that would necessarily lead to a decrease in the antenna bandwidth.

Therefore, the integration of such resonant antenna elements into small-sized wireless devices does not seem to be feasible.

For example, a quarter wavelength monopole antenna element operating in the FM frequency band would be about 85 cm long. For this reason, many mobile phones commercially available that integrate broadcast audio receivers for FM radio use the external cable that connects a headset to the mobile phone as the antenna element.

As a further example some prior-art mobile phones include a mechanically retractable external antenna element, which may have a length of more than 7 cm, to provide coverage for DVB-H or DMB standards.

An alternative approach involves the use of a non-resonant antenna element in the additional antenna system responsible for providing operability in one or more broadcast standards to a wireless handheld or portable device, as disclosed in patent application WO2007/128340.

Such an antenna element features an input impedance having an imaginary part not equal to zero for any frequency of the frequency region for which the antenna element is to operate, hence the name of non-resonant antenna element. In other words, the first resonance frequency of such antenna element occurs at a frequency much higher that the frequencies for which the antenna element is intended to operate.

A matching and tuning system operatively connected to the non-resonant antenna element transforms the input impedance of the antenna element and provides matching to the antenna system in the frequency region of operation.

One of the advantages of using non-resonant antenna elements is that the size of the antenna element is no longer proportional to the wavelengths of operation. This property can be advantageously exploited to obtain substantial size reduction of the antenna element, which makes it possible for an additional antenna system providing operability in a broadcast standard to be integrated inside the wireless handheld or portable device.

An example of this approach is illustrated in FIG. 1 with wireless handheld or portable device 100 (e.g., a mobile handset). An antenna system formed by the combination of an antenna element 101 and a ground plane layer 102 allows the wireless device 100 to operate one or more cellular communication standards (such as for instance GSM 900 and GSM 1800). In addition, a non-resonant antenna element 103 together with the same ground plane layer 102 forms an additional antenna system that allows the wireless device 100 to operate a broadcast audio and/or video standard (such as for instance DVB-H).

Despite substantial size-reduction with respect to resonant antenna elements, the size of a non-resonant antenna element may still not be sufficiently small to facilitate the integration of the additional antenna system within a wireless handheld or portable device.

Following with the example of FIG. 1, the presence of the non-resonant antenna element 103 at the lower end of the ground plane layer 102 increases the total length of the wireless device 100.

Also, patent application WO2008/119699 describes a wireless handheld or portable device comprising an antenna system capable of operating in two frequency regions. The antenna system disclosed therein comprises an antenna element having a resonance frequency outside said two frequency regions, and a ground plane layer.

Therefore, it would be desirable to provide a wireless handheld or portable device which is capable of operating one or more cellular communication standards and/or wireless connectivity standards and, at the same time, capable of operating one or more broadcast audio and/or video standards without necessarily increasing the size of the wireless device. This problem is solved by a wireless handheld or portable device according to the present invention.

It would also be desirable to upgrade existing wireless handheld or portable devices already operating one or more cellular communication standards and/or wireless connectivity standards by adding operability in one or more broadcast audio and/or video standards without necessarily requiring an increase in the size of the wireless device. This problem is solved by a method according to the present invention.

### SUMMARY OF THE INVENTION

A wireless handheld or portable device according to the present invention includes an antenna system capable of operation in a first frequency region and in a second frequency region, wherein the highest frequency of the second frequency region is lower than the lowest frequency of the first frequency region.

The wireless handheld or portable device may operate one, two, three, four or more cellular communication standards and/or wireless connectivity standards, each standard being allocated in one or more frequency bands, and said frequency bands being contained within said first frequency region of the electromagnetic spectrum. At the same time, the wireless handheld or portable device may operate one, two, three or more broadcast audio and/or video standards, each standard being allocated in one or more frequency bands, and said frequency bands being contained within said second frequency region of the electromagnetic spectrum.

In the context of this document, a frequency band preferably refers to a range of frequencies used by a particular cellular communication standard, a wireless connectivity standard or a broadcast standard; while a frequency region preferably refers to a continuum of frequencies of the electromagnetic spectrum. For example, the GSM 1800 standard is allocated in a frequency band from 1710 MHz to 1880 MHz while the GSM 1900 standard is allocated in a frequency band from 1850 MHz to 1990 MHz. A wireless device operating the GSM 1800 and the GSM 1900 standards must have an antenna system capable of operating in a frequency region from 1710 MHz to 1990 MHz.

Since the same antenna system operates in the first and second frequency regions providing both the cellular communication and/or wireless connectivity standards and the broadcast standards, the wireless handheld or portable device does not require of an additional antenna system to provide specifically the broadcast standards, which would lead to a volume overhead in the wireless device (for example, to accommodate an antenna element for that additional antenna system plus a possible ground plane layer clearance area around said antenna element), hence solving the problem of prior-art devices.

In accordance with a first aspect of the present invention, the antenna system comprises an antenna structure including: an antenna element having a first connection point; a ground plane layer having at least one connection point; and a first internal port, said first internal port being defined between the first connection point of the antenna element and one of the at least one connection point of the ground plane layer.

The antenna system further comprises a first external port for coupling electromagnetic wave signals in the first frequency region, a second external port for coupling electromagnetic wave signals in the second frequency region, and a radiofrequency system operatively connected between the first internal port of the antenna structure and the first and second external ports of the antenna system.

In this text, a port of the antenna structure is referred to as an internal port; while a port of the antenna system is referred to as an external port. In this context, the terms “internal” and “external” when referring to a port are used simply to distinguish a port of the antenna structure from a port of the antenna system, and carry no implication as to whether a port is accessible from the outside or not.

According to the first aspect of the present invention, the input impedance of the antenna structure at the first internal port when disconnected from the radiofrequency system features an imaginary part not equal to zero for any frequency of the second frequency region, so that the antenna structure is not resonant for any frequency of the second frequency region.

The radiofrequency system comprises a frequency-selective circuit arranged so as to operatively connect the second external port to the first internal port for the frequencies of the second frequency region but not for the frequencies of the first frequency region, and to operatively connect the first external port to the first internal port for the frequencies of the first frequency region but not for the frequencies of the second frequency region.

The frequency-selective circuit makes it possible for the antenna system to operate in the second frequency region without disturbing the performance of the antenna system in the first frequency region.

Said radiofrequency system modifies the impedance of the antenna structure, providing impedance matching to the antenna system in the second frequency region of operation of the antenna system. Since the same antenna system provides operability in both the first frequency region (for the cellular communication and/or wireless connectivity standards) and in the second frequency region (for the broadcast audio and/or video standards), no additional antenna system is required to specifically provide said second frequency band, hence solving the problem of the wireless handheld or portable devices of the prior-art.

In accordance with a second aspect of the present invention, the antenna element has also a second connection point, and the antenna structure further comprises a second internal port, said second internal port being defined between the second connection point of the antenna element and one of the at least one connection point of the ground plane layer.

In this case, the radiofrequency system is operatively connected between the first and second internal ports of the antenna structure and the first and second external ports of the antenna system.

According to the second aspect of the present invention, the input impedance of the antenna structure at each of the first and second internal ports when disconnected from the radiofrequency system features an imaginary part not equal to zero for any frequency of the second frequency region, so that the antenna structure is not resonant for any frequency of the second frequency region.

The radiofrequency system comprises a frequency-selective circuit arranged so as to effectively short-circuit the second internal port for the frequencies of the first frequency region but not for the frequencies of the second frequency region, to operatively connect the second external port to one of the first and the second internal ports for the frequencies of the second frequency region but not for the frequencies of the first frequency region, and to operatively connect the first external port to the first internal port for the frequencies of the first frequency region.

The frequency-selective circuit makes it possible for the antenna system to operate in the second frequency region without disturbing the performance of the antenna system in the first frequency region.

At the frequencies of the first frequency region, the frequency-selective circuit connects the first external port of the antenna system to the first internal port of the antenna structure and keeps the second internal port effectively short-circuited.

In the first frequency region, effectively short-circuiting the antenna element to the ground plane layer may be advantageous to adjust the input impedance level of the antenna structure, for example, around a resonance frequency of the antenna system.

At the frequencies of the second frequency region, the frequency-selective circuit connects the second external port to one of the internal ports of the antenna structure (either the first or the second internal port), while ensuring that in any case the second internal port is not short-circuited.

In the second frequency region, since the antenna element is non-resonant, its size is very small relative to the free-space wavelengths of operation. In that case, effectively short-circuiting the antenna element to the ground plane layer would have no beneficial effect on the input impedance level of the antenna structure. On the contrary, it would make such input impedance level substantially zero.

In a preferred example, the frequency-selective circuit loads the second internal port of the antenna structure with high impedance for the frequencies of the second frequency region.

Furthermore, said radiofrequency system modifies the impedance of the antenna structure, providing impedance matching to the antenna system in the second frequency region of operation.

Once again, since the same antenna system provides operability in both the first frequency region (for the cellular communication and/or wireless connectivity standards) and in the second frequency region (for the broadcast audio and/or video standards), no additional antenna system is required to specifically provide said second frequency band, hence solving the problem of the wireless handheld or portable devices of the prior-art.

In a preferred embodiment of the present invention, said frequency-selective circuit is arranged so as to operatively connect the second external port of the antenna system to the first internal port of the antenna structure for the frequencies of the second frequency region but not for the frequencies of the first frequency region, and to effectively disconnect the first external port of the antenna system from the first internal port of the antenna structure for the frequencies of the second frequency region.

In another preferred embodiment of the present invention, said frequency-selective circuit is arranged so as to operatively connect the second external port of the antenna system to the second internal port of the antenna structure for the frequencies of the second frequency region but not for the frequencies of the first frequency region.

In some examples according to the second aspect of the present invention, the antenna element comprises a single conducting portion including the first and the second connection points.

In a preferred example, said single conducting portion is the antenna element of a planar inverted-F antenna (PIFA) or an inverted-F antenna (IFA).

In some other examples, the antenna element comprises two separate conducting portions: a first portion including the first connection point of the antenna element, and a second portion including the second connection point of the antenna element.

Said first and second conducting portions are preferably arranged with respect to each other such that the two conducting portions are electromagnetically coupled (either capacitively or inductively coupled) to each other by means of a close proximity region. Said coupling may be advantageous to enhance the radioelectric performance of the antenna structure (such as, for instance, in terms of input impedance bandwidth) in the first frequency region.

In a preferred example said first and second conducting portions take the form of monopoles.

The present invention relates also to a method to provide operability in a second frequency region to an existing antenna system of a wireless handheld or portable device already operating in a first frequency region, said second frequency region having a highest frequency lower than a lowest frequency of said first frequency region.

In accordance with a third aspect of the present invention, the (existing) antenna system comprises an antenna structure including: an antenna element having a first connection point; a ground plane layer having at least one connection point, and a first internal port, said first internal port being defined between the first connection point of the antenna element and one of the at least one connection point of the ground plane layer.

The (existing) antenna system further comprises a first external port for coupling electromagnetic wave signals in the first frequency region, the first external port being operatively connected to the first internal port.

The input impedance at the first internal port of the antenna structure before being connected to the first external port features an imaginary part not equal to zero for any frequency of the second frequency region, so that the antenna structure is not resonant for any frequency of the second frequency region.

The method according to this third aspect of the present invention comprises the steps of: disconnecting the first external port from the first internal port; providing a second external port to the antenna system for coupling electromagnetic wave signals in the second frequency region; and providing a radiofrequency system to the antenna system, the radiofrequency system being operatively connected between the first internal port of the antenna structure and the first and second external ports of the antenna system.

The radiofrequency system comprises a frequency-selective circuit arranged so as to operatively connect the second external port to the first internal port for the frequencies of the second frequency region but not for the frequencies of the first frequency region, and to operatively connect the first external port to the first internal port for the frequencies of the first frequency region but not for the frequencies of the second frequency region, such that the resulting antenna system can operate in the second frequency region in addition to maintaining its operation in the first frequency region.

The method disclosed herein makes it possible to reuse the antenna system already included in an existing wireless handheld or portable device, and which provides operability in one or more mobile cellular and/or wireless connectivity standards within a first frequency region, to operate in a second frequency region without disturbing the performance of the antenna system in the first frequency region. In this way, the existing wireless device can be upgraded to provide one or more broadcast audio and/or video standards within said second frequency region, without necessarily requiring an increase in the size of the wireless device.

In accordance with a fourth aspect of the present invention, the antenna element of the (existing) antenna system has also a second connection point, and the antenna structure of the (existing) antenna system further comprises a second internal port, said second internal port being defined between the second connection point of the antenna element and one of the at least one connection point of the ground plane layer.

The second connection point of the antenna element is connected to said connection point of the ground plane layer used for defining the second internal port, such that the second internal port is effectively short-circuited.

Additionally, the input impedance at the second internal port of the antenna structure before being effectively short-circuited features an imaginary part not equal to zero for any frequency of the second frequency region, so that the antenna structure is not resonant (at neither its first nor its second internal port) for any frequency of the second frequency region.

The method according to this fourth aspect of the present invention comprises the steps of: disconnecting the first external port from the first internal port; removing the connection between the second connection point of the antenna element and said connection point of the ground plane layer used for defining the second internal port; providing a second external port to the antenna system for coupling electromagnetic wave signals in the second frequency region; and providing a radiofrequency system to the antenna system, the radiofrequency system being operatively connected between the first and the second internal ports of the antenna structure and the first an second external ports of the antenna system.

The radiofrequency system comprises a frequency-selective circuit arranged so as to effectively short-circuit the second internal port for the frequencies of the first frequency region but not for the frequencies of the second frequency region, to operatively connect the second external port to one of the first and the second internal ports for the frequencies of the second frequency region but not for the frequencies of the first frequency region, and to operatively connect the first external port to the first internal port for the frequencies of the first frequency region, such that the resulting antenna system can operate in the second frequency region in addition to maintaining its operation in the first frequency region.

In a preferred example, the frequency-selective circuit loads the second internal port of the antenna structure with high impedance for the frequencies of the second frequency region.

Once again, this method makes it possible to reuse the antenna system already included in an existing wireless handheld or portable device to provide one or more broadcast audio and/or video standards, without necessarily requiring an increase in the size of the wireless device.

In a preferred example, the first frequency region is located completely above 800 MHz and the second frequency region is located completely below 800 MHz.

In some examples, the first frequency region of the antenna system is preferably one of the following (or contained within one of the following): 824-960 MHz, 1710-2170 MHz, 2.4-2.5 GHz, 3.4-3.6 GHz, 4.9-5.875 GHz, or 3.1-10.6 GHz.

In some examples, the second frequency region of the antenna system is preferably one of the following (or contained within one of the following): 88-108 MHz, 470-702 MHz or 470-770 MHz.

In some examples, the antenna system is capable of operating, in addition to in the first and second frequency regions, in a third, a fourth, a fifth or even in more frequency regions of the electromagnetic spectrum. Some of said additional frequency regions may be located above the first frequency region, allowing the allocation of one, two, three or more frequency bands used in one or more standards of cellular communications and/or wireless connectivity services; whereas some of said additional frequency regions may be located below the first frequency region, allowing the allocation of one, two, three or more frequency bands used in one or more standards of broadcast services.

In some examples, a same connection point of the ground plane layer is used to define the first and the second internal ports of the radiating structure. In some other examples, a different connection point of the ground plane layer is used to define each of the first and the second internal ports.

In a preferred example, the antenna structure features at the/each internal port (e.g., at the first internal port, or at the first and second internal ports), when disconnected from the radiofrequency system, a first resonance frequency located above (i.e., higher than) the second frequency region of operation of the antenna system.

In the context of this document, a resonance frequency associated to an internal port of the antenna structure preferably refers to a frequency at which the input impedance measured at said internal port of the antenna structure, when disconnected from the radiofrequency system, has an imaginary part equal to zero.

In a more preferred example, the first resonance frequency at an internal port of the antenna structure is at the same time within the first frequency region of operation of the antenna system.

In some other examples, the first resonance frequency at an internal port is at the same time located below (i.e., at a frequency lower than) the first frequency region of operation of the antenna system. Hence, the first resonance frequency at said internal port is located above the second frequency region but below the first frequency region.

In some further cases, the first resonance frequency at the/each internal port of the antenna structure is also above the first frequency region of operation of the antenna system. Although in those cases, the first resonance frequency at an internal port of the antenna structure is preferably located within a third frequency region of operation of the antenna system, said third frequency region having a lowest frequency higher than the highest frequency of the first frequency region of operation of said antenna system.

In some examples, for the first internal port, or for the first and/or second internal ports, of the antenna structure, the ratio between the first resonance frequency at a given internal port of the antenna structure when disconnected from the radiofrequency system and the highest frequency of the second frequency region is preferably larger than a certain minimum ratio. Some possible minimum ratios are 1.0, 1.2, 1.4, 1.8, 2.2, 2.6, 3.0, 5.0, 7.0, 7.4, 7.8, 8.2, 8.6, 9.0 or 10.0. Setting the ratio high is advantageous because it reduces the size of the antenna element of the antenna structure, facilitating the integration of the antenna structure within the wireless handheld or portable device.

Since the second frequency range is much lower than the first resonance frequency at the/each internal port of the antenna structure (e.g., at the first internal port, or at the first and second internal ports), the input impedance of the antenna structure (measured at the/each internal port when the radiofrequency system is disconnected) features an important reactive component (either capacitive or inductive) within the range of frequencies of the second frequency region of operation. That is, the input impedance of the antenna structure at the/each internal port when disconnected from the radiofrequency system has an imaginary part not equal to zero for any frequency of the second frequency region.

However, if said ratio is too high it may become difficult to modify the input impedance of the antenna structure with the radiofrequency system to obtain an antenna system properly matched in the second frequency region of operation. Therefore, it is preferred in some cases the ratio between the first resonance frequency at a given internal port of the antenna structure when disconnected from the radiofrequency system and the highest frequency of the second frequency region be less than a certain maximum ratio. Some possible maximum ratios are 16.0, 14.0, 12.0, 10.0, 9.0, 8.5, 5.0, 4.0, 3.5, 3.0, 2.5, 2.0, 1.8 or 1.4.

Furthermore, in some cases it is advantageous to set said ratio between a certain minimum value and a certain maximum value.

The radiofrequency system is operatively arranged between the first internal port (or the first and second internal ports) of the antenna structure and the first and second external ports of the antenna system.

In accordance with the present invention, the radiofrequency system comprises a frequency-selective circuit. The frequency-selective circuit is preferably connected to the internal port (or internal ports) of the antenna structure and to the first external port of the antenna system.

In some embodiments, the radiofrequency system further comprises a matching network to transform the input impedance of the antenna structure, providing impedance matching to the antenna system in the second frequency region of operation of the antenna system. Said matching network is advantageously operatively arranged between the frequency-selective circuit and the second external port of the antenna system.

In some embodiments, the frequency-selective circuit comprises a diplexer or a bank of filters to separate, or to combine, the electrical signals of the first and second frequency regions of operation of the antenna system.

In an example, the diplexer is operatively connected to an internal port of the antenna structure. In another example, the diplexer can be replaced by a bank of two band-pass filters and a combiner/splitter. A first band-pass filter (or, alternatively, a high-pass filter) is designed to introduce low insertion loss in the first frequency region and to present high impedance to the combiner/splitter in the second frequency region. A second band-pass filter (or, alternatively, a low-pass filter) is designed to introduce low insertion loss in the second frequency region and to present high impedance to the combiner/splitter in the first frequency region. The combiner/splitter combines (or splits) the electrical signals of the two frequency regions of operation of the antenna system.

In the context of this document high impedance in a given frequency region preferably refers to an impedance having a modulus not smaller than 300 Ohms, 500 Ohms, 800 Ohms, 1000 Ohms or even 1500 Ohms for any frequency within said frequency region, and more preferably being substantially reactive (i.e., having a real part substantially close to zero) within said given frequency region.

In those antenna structures comprising a first internal port and a second internal port, the frequency-selective circuit is additionally arranged so as to effectively short-circuit the second internal port for the frequencies of the first frequency region but not for the frequencies of the second frequency region.

In some examples, the frequency-selective circuit includes a frequency-selective load comprising at least one stage operatively connected to the second internal port of the antenna structure designed to present high impedance to said second internal port in the second frequency region and to present low impedance to said second internal port in the first frequency region, so as to effectively short-circuit it.

In an example, said frequency-selective load is operatively connected to the second internal port of the antenna structure through a diplexer or through a bank of filters, while in another example said frequency-selective load is connected directly to said second internal port.

In the context of this document, an internal port of the antenna structure is effectively short-circuited in a given frequency region when the impedance presented to said internal port has a modulus not larger than 20 Ohms, 15 Ohms, 10 Ohms, or even 5 Ohms for any frequency within said frequency region, and more preferably being substantially reactive (i.e., having a real part substantially close to zero) within said given frequency region.

The matching network can comprise a single stage or a plurality of stages. In some examples, the matching network comprises at least two, at least three, at least four, at least five, at least six, at least seven, at least eight or more stages.

A stage of the frequency-selective circuit or of the matching network comprises one or more circuit components (such as for example but not limited to inductors, capacitors, resistors, jumpers, short-circuits, switches, delay lines, resonators, or other reactive or resistive components). In some cases, a stage has a substantially inductive behavior in the frequency regions of operation of the antenna system, while another stage has a substantially capacitive behavior in said frequency regions, and yet a third one may have a substantially resistive behavior in said frequency regions.

A stage can be connected in series or in parallel to other stages and/or to an internal port of the antenna structure and/or to an external port of the antenna system.

In some examples, the frequency-selective circuit and/or the matching network alternate stages connected in series (i.e., cascaded) with stages connected in parallel (i.e., shunted), forming a ladder structure. In some cases, a frequency-selective circuit and/or a matching network comprising two stages forms an L-shaped structure (i.e., series—parallel or parallel—series). In some other cases, a frequency-selective circuit and/or a matching network comprising three stages forms either a pi-shaped structure (i.e., parallel—series—parallel) or a T-shaped structure (i.e., series—parallel—series).

In some examples, the frequency-selective circuit and/or the matching network alternates stages having a substantially inductive behavior, with stages having a substantially capacitive behavior.

In an example, a stage may substantially behave as a resonant circuit (such as, for instance, a parallel LC resonant circuit or a series LC resonant circuit) in at least one frequency region of operation of the antenna system (such as for instance in the first or the second frequency region). The use of stages having a resonant circuit behavior allows one part of the radiofrequency system be operatively connected to another part of the radiofrequency system for a given range of frequencies, or in a given frequency range, and be effectively disconnected in another range of frequencies, or in another frequency range. A frequency-selective circuit may advantageously comprise one or more of such stages.

In an example, the frequency-selective circuit and/or the matching network comprise at least one active circuit component (such as for instance, but not limited to, a transistor, a diode, a MEMS device, a relay, or an amplifier) in at least one stage.

In some examples, at least some circuit components in the stages of the frequency-selective circuit and/or the matching network are discrete lumped components (such as for instance SMT components), while in some other examples all the circuit components of the frequency-selective circuit and/or the matching network are discrete lumped components. In some examples, at least some circuit components in the stages of the frequency-selective circuit and/or the matching network are distributed components (such as for instance a transmission line printed or embedded in a PCB containing the ground plane layer of the antenna structure), while in some other examples all the circuit components of the frequency-selective circuit and/or the matching network are distributed components.

In some embodiments, the matching network preferably includes a reactance cancellation circuit comprising one or more stages, with one of said one or more stages being connected, through the frequency-selective circuit, to an internal port of the antenna structure.

In the context of this document, reactance cancellation preferably refers to compensating the imaginary part of the input impedance at an internal port of the antenna structure when disconnected from the radiofrequency system so that the input impedance of the antenna system at the second external port has an imaginary part substantially close to zero for a frequency preferably within the second frequency region of operation. In some less preferred examples, said frequency may also be higher than the highest frequency of said second frequency region (although preferably not higher than 1.1, 1.2, 1.3 or 1.4 times said highest frequency) or lower than the lowest frequency of said second frequency region (although preferably not lower than 0.9, 0.8 or 0.7 times said lowest frequency). Moreover, the imaginary part of an impedance is considered to be substantially close to zero if it is not larger (in absolute value) than 15 Ohms, and preferably not larger than 10 Ohms, and more preferably not larger than 5 Ohms.

In a preferred embodiment, the antenna structure features at an internal port when the radiofrequency system is disconnected from said internal port an input impedance having a capacitive component for the frequencies of the second frequency region of operation. In that embodiment, a matching network operatively connected to said internal port (via the frequency-selective circuit) includes a reactance cancellation circuit that comprises a first stage having a substantially inductive behavior for all the frequencies of the second frequency region of operation of the antenna system. More preferably, said first stage comprises an inductor. In some cases, said inductor may be a lumped inductor. Said first stage is advantageously connected, through the frequency-selective circuit, in series with said internal port of the antenna structure.

In another preferred embodiment, the antenna structure features at an internal port when the radiofrequency system is disconnected from said internal port an input impedance having an inductive component for the frequencies of the second frequency region of operation. In that embodiment, a matching network operatively connected to said internal port (via the frequency-selective circuit) includes a reactance cancellation circuit that comprises a first stage and a second stage forming an L-shaped structure, with said first stage being connected in parallel and said second stage being connected in series. Each of the first and the second stage has a substantially capacitive behavior for all the frequencies of the second frequency region of operation of the antenna system. More preferably, said first stage and said second stage comprise each a capacitor. In some cases, said capacitor may be a lumped capacitor. Said first stage is advantageously connected, through the frequency-selective circuit, in parallel with said internal port of the antenna structure, while said second stage is connected to said first stage.

In some embodiments, the matching network may further comprise a broadband matching circuit, said broadband matching circuit being preferably connected in cascade to the reactance cancellation circuit. With a broadband matching circuit, the impedance bandwidth of the antenna structure may be advantageously increased. This may be particularly interesting for those cases in which the relative bandwidth of the second frequency region is large.

In a preferred embodiment, the broadband matching circuit comprises a stage that substantially behaves as a resonant circuit (preferably as a parallel LC resonant circuit or as a series LC resonant circuit) in one of the first and second frequency regions of operation of the antenna system, and more preferably in said second frequency region.

In some examples, the matching network may further comprise in addition to the reactance cancellation circuit and/or the broadband matching circuit, a fine tuning circuit to correct small deviations of the input impedance of the antenna system with respect to some given target specifications.

In a preferred example, a matching network comprises: a reactance cancellation circuit connected to the frequency selective circuit; and a fine tuning circuit connected to the second external port of the antenna system. In an example, said matching network further comprises a broadband matching circuit operatively connected in cascade between the reactance cancellation circuit and the fine tuning circuit. In another example, said matching network does not comprise a broadband matching circuit and the reactance cancellation circuit is connected in cascade directly to the fine tuning circuit.

In some examples, one, two, three or even all the stages of the matching network may contribute to more than one functionality of said matching network. A given stage may for instance contribute to two or more of the following functionalities from the group comprising: reactance cancellation, impedance transformation (preferably, transformation of the real part of said impedance), broadband matching and fine tuning matching. In other words, a same stage of the matching network may advantageously belong to two or three of the following circuits: reactance cancellation circuit, broadband matching circuit and fine tuning circuit. Using a same stage of the matching network for several purposes may be advantageous in reducing the number of stages and/or circuit components required for the matching network of a radiofrequency system, reducing the real estate requirements on the PCB of the wireless handheld or portable device in which the antenna system is integrated.

In other examples, each stage of the matching network serves only to one functionality within the matching network. Such a choice may be preferred when low-end circuit components, having for instance a worse tolerance behavior, a more pronounced thermal dependence, and/or a lower quality factor, are used to implement said matching network.

In some further examples, one, two, three or more stages of the radiofrequency system may advantageously belong to the frequency-selective circuit and to the matching network.

The wireless handheld or portable device according to the present invention may have a candy-bar shape, which means that its configuration is given by a single body. It may also have a two-body configuration such as a clamshell, flip-type, swivel-type or slider structure. In some other cases, the device may have a configuration comprising three or more bodies. It may further or additionally have a twist configuration in which a body portion (e.g. with a screen) can be twisted (i.e., rotated around two or more axes of rotation which are preferably not parallel).

In the context of the present document a wireless handheld or portable device is considered to be slim if it has a thickness of less than 14 mm, 13 mm, 12 mm, 11 mm, 10 mm, 9 mm or 8 mm.

In some examples, a wireless handheld or portable device advantageously comprises at least five functional blocks: a user interface module, a processing module, a memory module, a communication module and a power management module. The user interface module comprises a display, such as a high resolution LCD, OLED or equivalent, and is an energy consuming module, most of the energy drain coming typically from the backlight use. The user interface module may also comprise a keypad and/or a touchscreen, and/or an embedded stylus pen. The processing module, that is a microprocessor or a CPU, and the associated memory module are also major sources of power consumption. The fourth module responsible of energy consumption is the communication module, in which the antenna system is included. The power management module of the wireless handheld or portable device includes a source of energy (such as for instance, but not limited to, a battery or a fuel cell) and a power management circuit that manages the energy of the device.

A wireless handheld or portable device generally comprises one, two, three or more multilayer printed circuit boards (PCBs) on which to carry the electronics. In a preferred embodiment, the ground plane layer of the antenna structure is at least partially, or completely, contained in at least one of the layers of a multilayer PCB of the wireless handheld or portable device.

In some cases, a wireless handheld or portable device may comprise two, three, four or more ground plane layers. For example a clamshell, flip-type, swivel-type or slider-type wireless device may advantageously comprise two PCBs, each including a ground plane layer.

In a preferred example of the present invention, a major portion of the antenna element (such as at least a 50%, or a 60%, or a 70%, or an 80% of the surface of said antenna element) is placed on one or more planes substantially parallel to the ground plane layer. In the context of this document, two surfaces are considered to be substantially parallel if the smallest angle between a first line normal to one of the two surfaces and a second line normal to the other of the two surfaces is not larger than 30°, and preferably not larger than 20°, or even more preferably not larger than 10°.

In a preferred example, the antenna structure is arranged within the wireless handheld or portable device in such a manner that there is no ground plane in the orthogonal projection of the antenna element onto the plane containing the ground plane layer. In some examples there is some overlapping between the projection of the antenna element and the ground plane layer. In some embodiments less than a 10%, a 20%, a 30%, a 40%, a 50%, a 60% or even a 70% of the area of the projection of the antenna element overlaps the ground plane layer. Yet in some other examples, the projection of the antenna element onto the ground plane layer completely overlaps the ground plane layer.

In some cases it is advantageous to protrude at least a portion of the orthogonal projection of the antenna element beyond the ground plane layer, or alternatively remove ground plane from at least a portion of the projection of the antenna element, in order to adjust the levels of impedance and to enhance the impedance bandwidth of the antenna structure. This aspect is particularly suitable for those examples in which the volume for the integration of the antenna structure has a small height, as it is the case in particular for slim wireless handheld or portable devices.

The present invention can be applied to antenna structures with different antenna topologies, preferably unbalanced antenna topologies. In particular, monopoles, folded and/or loaded monopoles, and their slot or aperture equivalents (slot monopoles, folded and/or loaded slot monopoles) are some of the topologies in which the present invention can be applied. Other antenna topologies include shorted and bent monopoles (L-shaped monopoles, inverted-F antennas or IFA), and again their aperture equivalents. Another possible antenna configuration is a microstrip or patch antenna, including their shorted versions (shorted patches and PIFAs). All of these antenna topologies could be used in the antenna structure for an antenna system according to the present invention.

### LIST OF FIGURES

Embodiments of the invention are shown in the enclosed figures. Herein shows:

FIG. 1—Known wireless handheld or portable device capable of operating a cellular communication standard and a broadcast standard.

FIG. 2—(a) Schematic representation of an antenna system for a wireless handheld or portable device according to a first aspect of the present invention; and (b) Schematic representation of an antenna system for a wireless handheld or portable device according to a second aspect of the present invention.

FIG. 3—Block diagram of a typical radiofrequency system used in an antenna system according to the first aspect of the present invention.

FIG. 4—Block diagram of two examples of radiofrequency systems suitable for an antenna system according to the second aspect of the present invention.

FIG. 5—Block diagram of three examples of matching networks for a radiofrequency system used in an antenna system according to the present invention.

FIG. 6—Example of an antenna structure for an antenna system, the antenna structure including an antenna element that comprises a single conducting portion.

FIG. 7—Typical reflection coefficient observed at a first external port of an antenna system based on the antenna structure of FIG. 6 if said antenna system was intended for operation in the first and third frequency regions but not in the second frequency region.

FIG. 8—Schematic representation of a radiofrequency system for an antenna system according to the present invention whose antenna structure is shown in FIG. 6.

FIG. 9—Schematic representation of a matching network used in the radiofrequency system of FIG. 6.

FIG. 10—Typical impedance transformation caused by the matching network of FIG. 9 on the input impedance at the first internal port of the antenna structure of FIG. 6: (a) Input impedance at the first internal port when disconnected from the matching network of the radiofrequency system; (b) Input impedance after operatively connecting a reactance cancellation circuit to the first internal port; and (c) Input impedance after connection of a broadband matching circuit in cascade with the reactance cancellation circuit.

FIG. 11—Typical reflection coefficient at the first internal port of the radiating structure of FIG. 6 compared with the reflection coefficient at the second external port of an antenna system resulting from the interconnection of the radiofrequency system of FIG. 8 to the antenna structure of FIG. 6.

FIG. 12—Perspective view of another example of an antenna structure for an antenna system according to the present invention, the antenna structure including an antenna element that comprises two separate conducting portions.

FIG. 13—Schematic representation of three examples of frequency-selective loads for a radiofrequency system used in an antenna system according to the present invention.

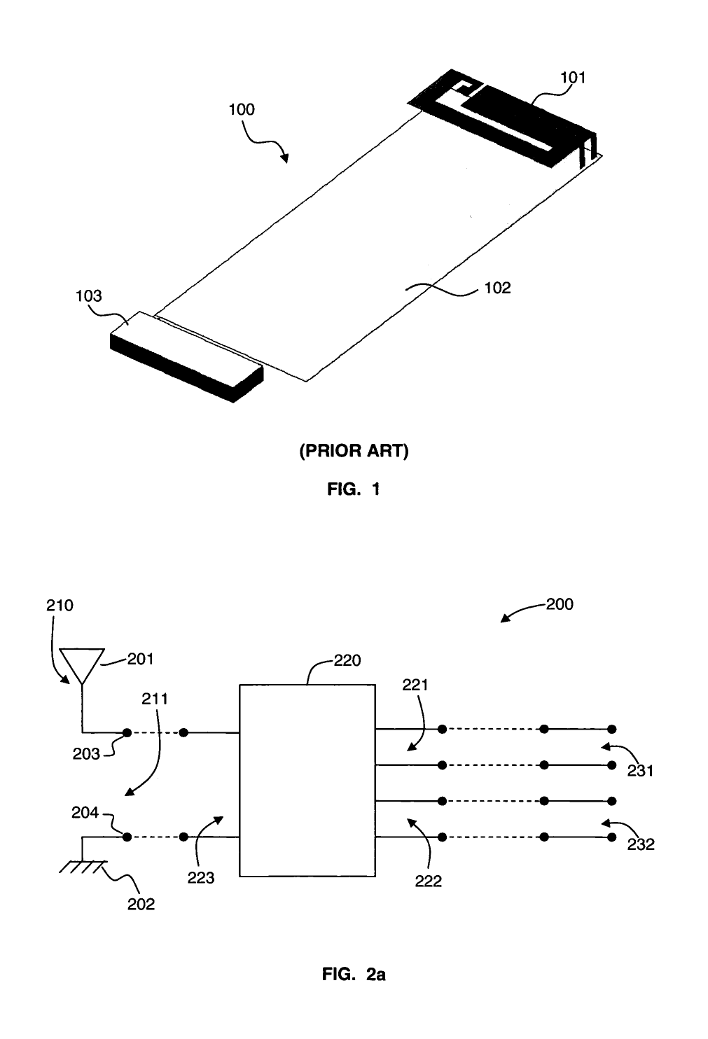

### DETAILED DESCRIPTION OF THE FIGURES

Further characteristics and advantages of the invention will become apparent in view of the detailed description of some preferred embodiments which follows. Said detailed description of some preferred embodiments of the invention is given for purposes of illustration only and in no way is meant as a definition of the limits of the invention, made with reference to the accompa-nying figures.

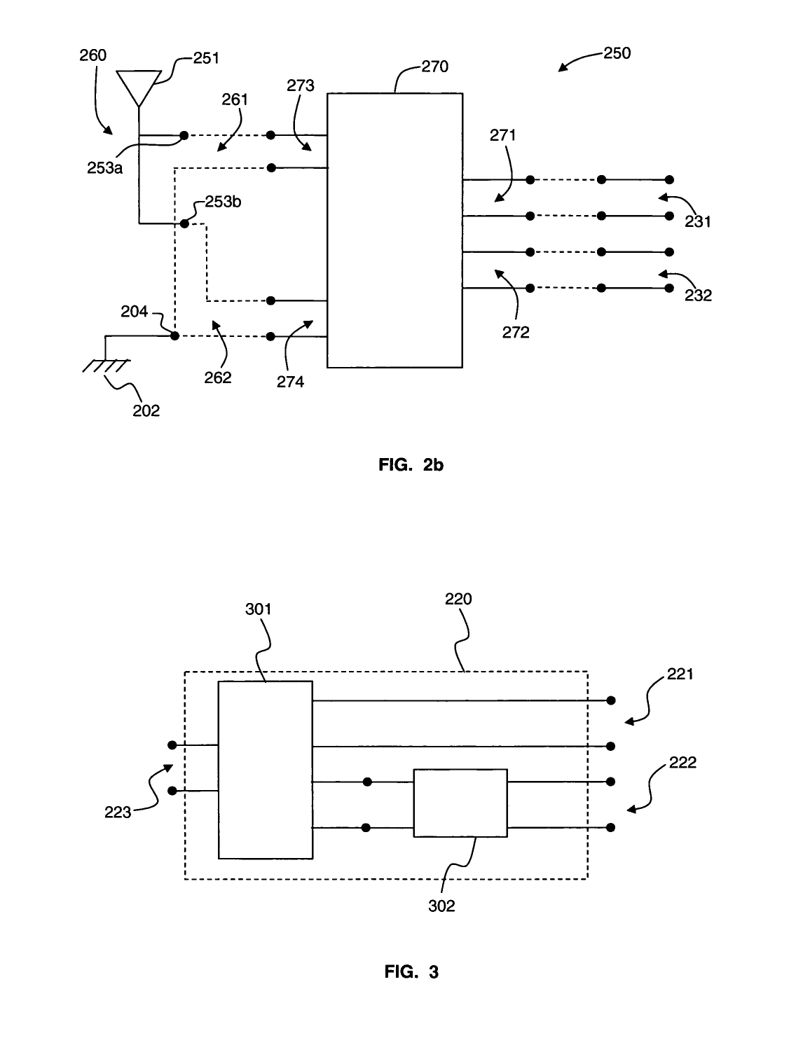

FIG. 2 shows a schematic representation of two examples of antenna systems for a wireless handheld or portable device capable of operating in a first and in a second frequency region in accordance with the present invention.

In particular, FIG. 2a represents an antenna system 200 according to the first aspect of the present invention, which comprises an antenna structure 210 having an antenna element 201 that includes a connection point 203, and a ground plane layer 202 that also includes a connection point 204. The antenna structure 210 further comprises a first internal port 211 defined between the connection point 203 and the connection point 204.

The antenna system 200 also comprises a first external port 231 to couple electromagnetic wave signals in the first frequency region (to provide operability for at least one cellular communication and/or wireless connectivity standard) and a second external port 232 to couple electromagnetic wave signals in the second frequency region (to provide operability for at least one broadcast standard).

The antenna system 200 further comprises a radiofrequency system 220 including three ports: A first port 221 is connected to the first external port 231; a second port 222 is connected to the second external port 232; and a third port 223 is connected to the first internal port 211 of the antenna structure 210. That is, the radiofrequency system 220 is operatively connected between the internal port 211 of the antenna structure 210 and the external ports 231, 232 of the antenna system 200.

Referring now to FIG. 2b, it is there depicted an example of an antenna system according to the second aspect of the present invention. The antenna system 250 comprises an antenna structure 260 having an antenna element 251 which, in addition to including a first connection point 253a as in the previous example, it also includes a second connection point 253b. The antenna structure 260 further comprises a ground plane layer 202 including a connection point 204. As a result, the antenna structure 260 comprises now two internal ports: a first internal port 261 is defined between said first connection point 253a and the connection point 204 of the ground plane layer 202; and a second internal port 262 is defined between said second connection point 253b and the connection point 204 of the ground plane layer 202.

The antenna system 250 further comprises a radiofrequency system 270 which is operatively connected between the two internal ports 261, 262 of the antenna structure 210 and the two external ports of the antenna system 250 (a first external port 231 and a second external port 232, as in the previous example). For such a purpose, the radiofrequency system 270 includes four ports: A first port 271 is connected to the first external port 231; a second port 272 is connected to the second external port 232; a third port 273 is connected to the first internal port 261; and a fourth port 274 is connected to the second internal port 262.

FIG. 3 shows, in the form of a block diagram, a radiofrequency system 220 suitable for an antenna system in accordance with the first aspect of the present invention, such as for example the antenna system 200 in FIG. 2a. The radiofrequency system 220 comprises a frequency-selective circuit 301 and a matching network 302.

In this example, the frequency selective circuit 301 is directly connected to the first port 221 of the radiofrequency system 220 (i.e., the port for connection to the first external port of an antenna system) and to the third port 223 of the radiofrequency system 220 (i.e., the port to be connected to the first internal port of an antenna structure). Furthermore, the frequency-selective circuit 301 is operatively connected to the second port 222 of the radiofrequency system 220 (i.e., the port for connection to the second external port of an antenna system) through the matching network 302, which is in turn connected to said second port 222.

The frequency-selective circuit 301 may take in this case the form of a diplexer, or alternatively a bank of filters, so that the third port 223 is operatively connected to the first port 221 for the frequencies of the first frequency region but not for the frequencies of the second frequency region, and the third port 223 is operatively connected (through the matching network 302) to the second port 222 for the frequencies of the second frequency region but not for the frequencies of the first frequency region.

When an antenna structure is connected to the radiofrequency system 220, the matching network 302 transforms the input impedance of said antenna structure providing impedance matching to the resulting antenna system in the second frequency region of operation.

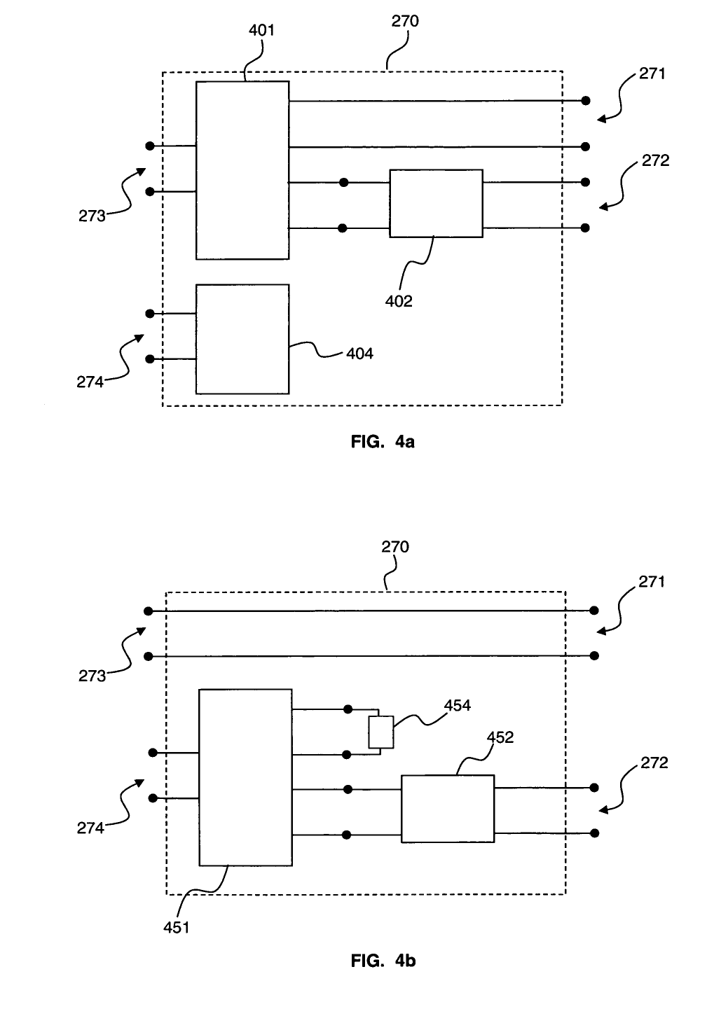

FIG. 4 presents a couple of examples of a radiofrequency system 270 to be used in an antenna system according to the second aspect of the present invention, such as for example the antenna system 250 in FIG. 2b.

In these examples, the radiofrequency system 270 includes four ports. A first port 271 and a second port 272 of the radiofrequency system 270 are for connection, respectively, with a first external port and a second external port of an antenna system. A third port 273 and a fourth port 274 of the radiofrequency system 270 are for connection, respectively, with a first internal port and a second internal port of an antenna structure included in said antenna system.

In FIG. 4a, the radiofrequency system 270 comprises a matching network 402 and a frequency-selective circuit including a first block 401 and a second block 404.

The first block 401 of the frequency-selective circuit is connected to the first port 271, to the third port 273 and also, through the matching network 402, to the second port 272.

In this example, said first block 401 comprises a diplexer that operatively connects the third port 273 to the first port 271 for the frequencies of the first frequency region but not for the frequencies of the second frequency region, and that operatively connects (through the matching network 402) the third port 273 to the second port 272 for the frequencies of the second frequency region but not for the frequencies of the first frequency region.

The second block 404 of the frequency-selective circuit is connected to the fourth port 274. Said second block 404 is a frequency-selective load which effectively short-circuits the fourth port 274 for the frequencies of the first frequency region but not for the frequencies of the second frequency region. Moreover, said second block 404 preferably loads the fourth port 274 with high impedance for the frequencies of the second frequency region.

FIG. 4b depicts another example of a radiofrequency system 270 comprising a matching network 452 and a frequency-selective circuit, which again includes a first block 451 and a second block 454.

In this example, the first block 451 of the frequency-selective circuit is connected to the fourth port 274 and also (although through the matching network 452) to the second port 272 of the radiofrequency system 270. Said first block 451 is also connected to the second block 454 of the frequency-selective circuit. Finally, the first port 271 and the third port 273 of the radiofrequency system 270 are directly connected to each other.

Said first block 451 comprises a diplexer that operatively connects the fourth port 274 to said second block 454 for the frequencies of the first frequency region but not for the frequencies of the second frequency region, and that operatively connects (through the matching network 402) the fourth port 274 to the second port 272 for the frequencies of the second frequency region but not for the frequencies of the first frequency region.

The second block 454 of the frequency-selective circuit may in some cases be a frequency-selective load which is effectively short-circuited for the frequencies of the first frequency region but not for the frequencies of the second frequency region. In some other cases, said second block 454 may be a short-circuit (or comprise a stage behaving effectively as a short-circuit) for the frequencies of both the first and second frequency regions.

The first block 451 and the second block 454 of the frequency-selective circuit are arranged so as to effectively short-circuit the fourth port 274 of the radiofrequency system 270 for the frequencies of the first frequency region but not for the frequencies of the second frequency region and, in some cases, load the fourth port 274 with high impedance for the frequencies of said second frequency region.

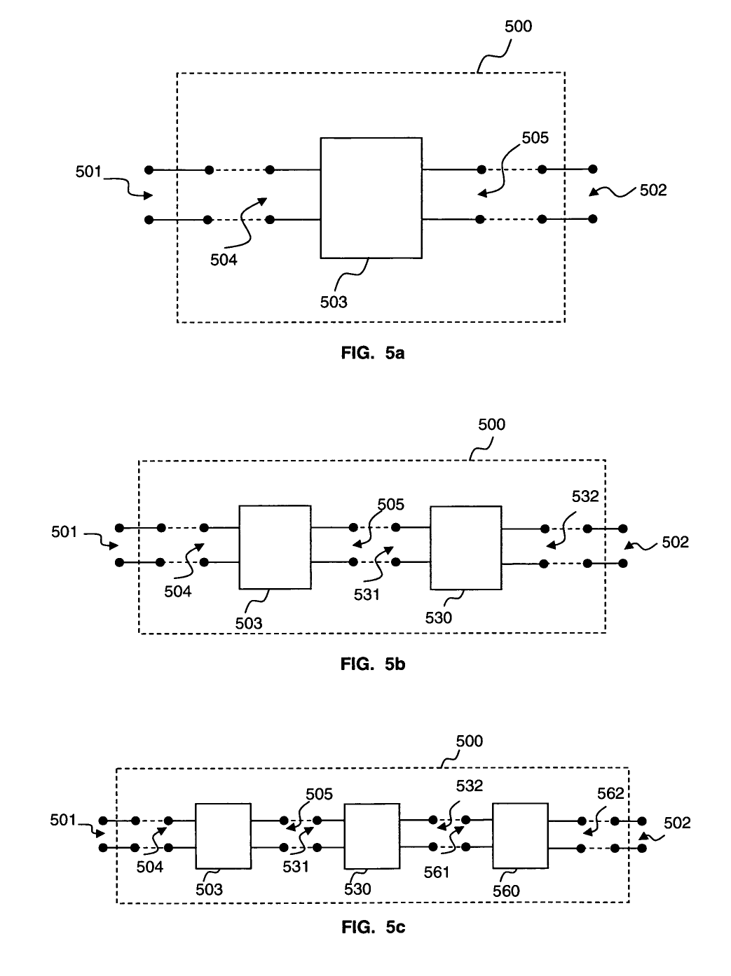

FIG. 5 shows the block diagram of three preferred examples of a matching network 500 for a radiofrequency system, the matching network 500 comprising a first port 501 and a second port 502. One of said two ports may typically be connected to a frequency-selective circuit of a radiofrequency system, while the other of said two ports may at the same time be a port of a radiofrequency system and, in particular, be connected to the second external port of an antenna system.

In FIG. 5a the matching network 500 comprises a reactance cancellation circuit 503. In this example, a first port of the reactance cancellation circuit 504 may be operatively connected to the first port of the matching network 501 and another port of the reactance cancellation circuit 505 may be operationally connected to the second port of the matching network 502.

Referring now to FIG. 5b, the matching network 500 comprises the reactance cancellation circuit 503 and a broadband matching circuit 530, which is advantageously connected in cascade with the reactance cancellation circuit 503. That is, a port of the broadband matching circuit 531 is connected to port 505. In this example, port 504 is operatively connected to the first port of the matching network 501, while another port of the broadband matching circuit 532 is operatively connected to the second port of the matching network 502.

FIG. 5c depicts a further example of the matching network 500 comprising, in addition to the reactance cancellation circuit 503 and the broadband matching circuit 530, a fine tuning circuit 560. Said three circuits are advantageously connected in cascade, with a port of the reactance cancellation circuit (in particular port 504) being connected to the first port of the matching network 501 and a port the fine tuning circuit 562 being connected to the second port of the matching network 502. In this example, the broadband matching circuit 530 is operatively connected between the reactance cancellation circuit 503 and the fine tuning circuit 560 (i.e., port 531 is connected to port 505 and port 532 is connected to port 561 of the fine tuning circuit 560).

Any of the matching networks 302, 402 and 452 in the example radiofrequency systems 220, 270 of FIGS. 3 and 4 may advantageously be as the matching network 500 of any of FIGS. 5a-c.

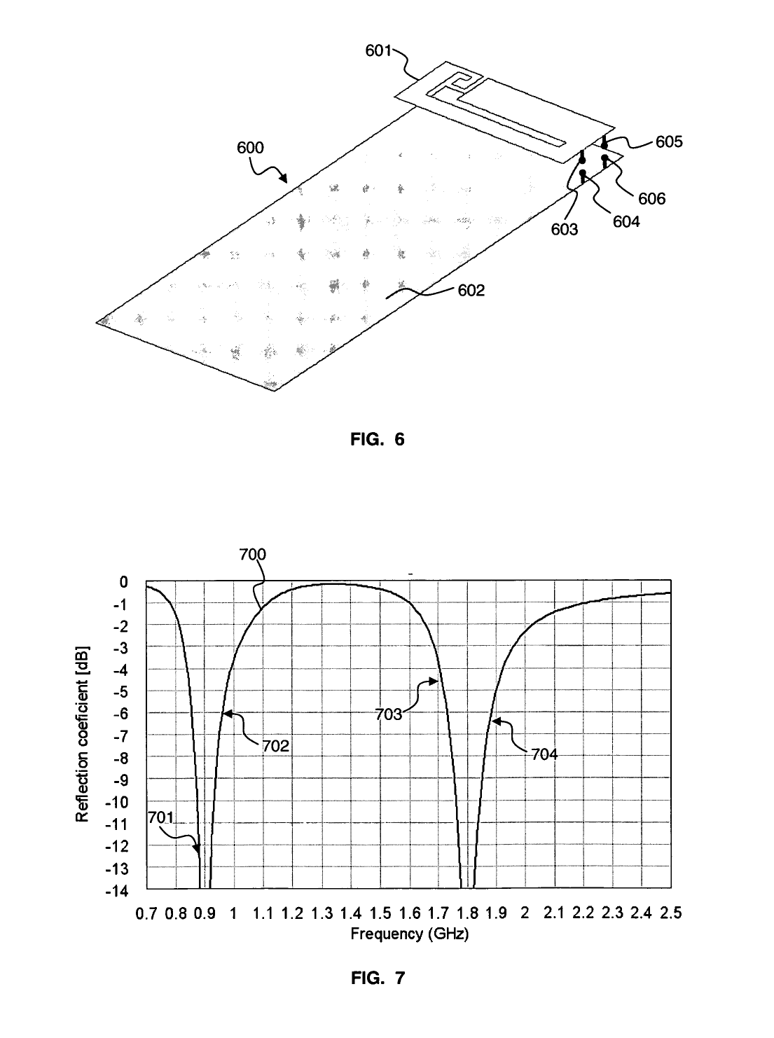

FIG. 6 shows an example of an antenna structure suitable for an antenna system operating in a first frequency region of the electromagnetic spectrum between 880 MHz and 960 MHz. In accordance with the present invention the same antenna structure allows the antenna system to operate in a second frequency region between 88 MHz and 108 MHz. Furthermore, the antenna structure also makes it possible for the antenna system to operate in a third frequency region between 1710 MHz and 1880 MHz.

A wireless handheld or portable device including such an antenna system may advantageously operate the GSM 900 and GSM1800 cellular communication standards (the first one allocated in said first frequency region and the other one in said third frequency region) and the FM broadcast standard (allocated in said second frequency region).

The antenna structure 600 comprises an antenna element 601 and a ground plane layer 602. In this example, the antenna element 601 is formed by a single conducting portion and comprises a first connection point 603 and a second connection point 605. Said first and second connection points 603, 605 are located substantially on the external perimeter of the antenna element 601.

The ground plane layer 602 comprises also a first connection point 604 and a second connection point 606. In this example, the ground plane layer 602 has a substantially rectangular shape, with a long side of approximately 100 mm and a short side of approximately 40 mm, being these the typical dimensions for the ground plane layer of a mobile phone.

A first internal port of the antenna structure 600 is defined between the first connection point 603 of the antenna element 601 and the first connection point 604 of the ground plane layer 602. Similarly, a second internal port of the antenna structure 600 is defined between the second connection point 605 of the antenna element 601 and the second connection point 606 of the ground plane layer 602.

In an alternative example, the ground plane layer 602 of the antenna structure 600 may comprise only the first connection point 604 (i.e., only one connection point). In that case the second internal port of the antenna structure 600 could have been defined between the second connection point 605 of the antenna element 601 and the first connection point 604 of the ground plane layer 602.

In FIG. 6, the antenna element 601 is substantially planar and is arranged on a plane substantially parallel to the ground plane layer 602. Moreover, in this example the antenna element 601 is located above the ground plane layer 602. That is, the orthogonal projection of the antenna element 601 onto the plane containing the ground plane layer 602 completely overlaps the ground plane layer 602. Therefore, the antenna structure 600 could correspond to the topology of a PIFA.

If the antenna structure 600 was used in a conventional way to obtain an antenna system only capable of operating said two cellular communication standards but not the broadcast standard (i.e., an antenna system operating in the first and third frequency regions but not in the second frequency region), the second internal port of the antenna structure 600 would be short-circuited and the first internal port of the antenna structure 600 would become the first (and in fact single) external port of the antenna system. Through that first external port, electromagnetic wave signals in the first and third frequency regions could be coupled to the antenna structure 600.

If operated in such a conventional way, the typical performance of said antenna system could be as the one depicted in FIG. 7, in which curve 700 corresponds to the reflection coefficient for the antenna system as observed at its first external port. Curve 700 features a reflection coefficient better than −6 dB in the first frequency region (delimited by points 701 and 702 on the curve 700) and also in the third frequency region (delimited by points 703 and 704 on the curve 700).

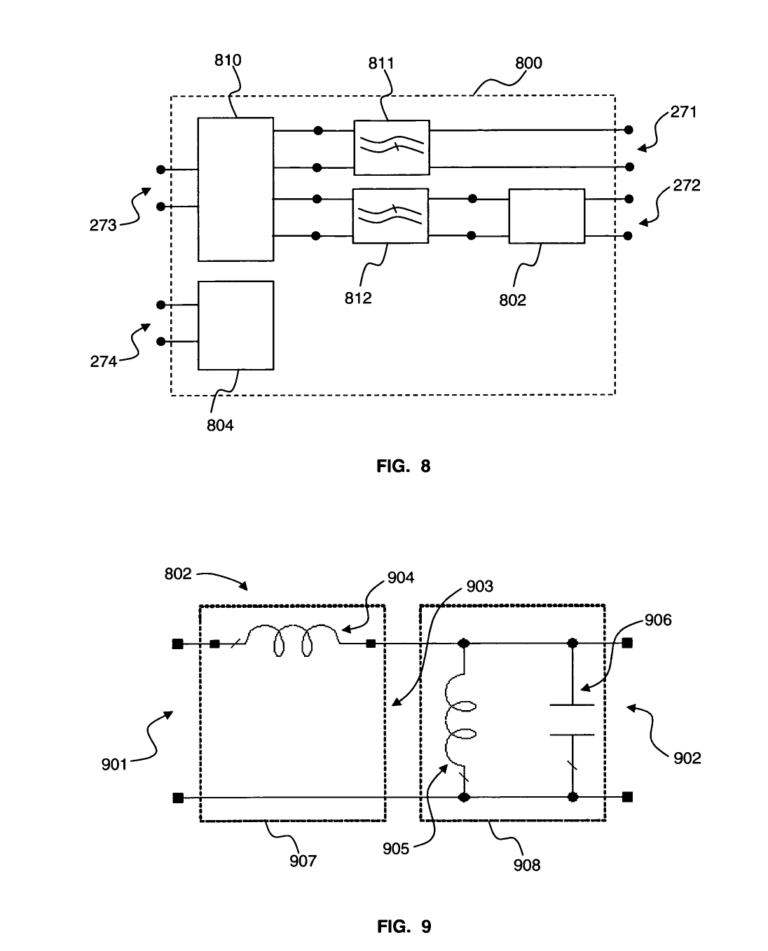

In accordance with an aspect of the present invention, an antenna system based on the antenna structure 600 can advantageously provide the three frequency regions. Such an antenna system comprises a radiofrequency system (as for example that shown in FIG. 8) including a frequency-selective circuit which allows adding the operability in the second frequency region while maintaining the operability in the first frequency region and, in this particular example, also in the third frequency region.

In accordance with the present invention, the antenna structure 600 features at its first internal port, when no radiofrequency system is connected to it, a first resonance frequency at approximately 925 MHz. Said first resonance frequency is advantageously located above the second frequency region of operation. Moreover, said first resonance frequency is at the same time within the first frequency region.

In this example, the ratio between the first resonance frequency at the first internal port of the antenna structure 600 (when not connected to a radiofrequency system) and the highest frequency of the second frequency region is advantageously larger than 7.8, although smaller than 9.0.

Similarly, the first resonance frequency at the second internal port of the antenna structure 600 (before connection to the radiofrequency system) occurs at a frequency also located above the second frequency region.

As a result, the input impedance of the antenna structure 600 measured at each of the first and second internal ports features an important reactive component, and in particular a capacitive component, within the frequencies of the second frequency region.

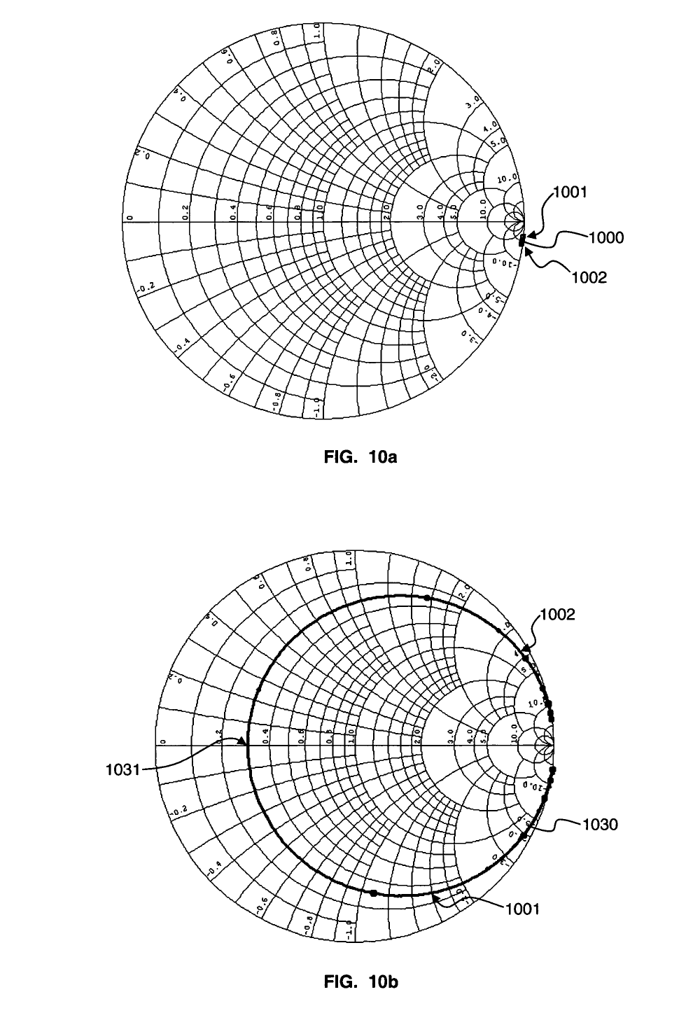

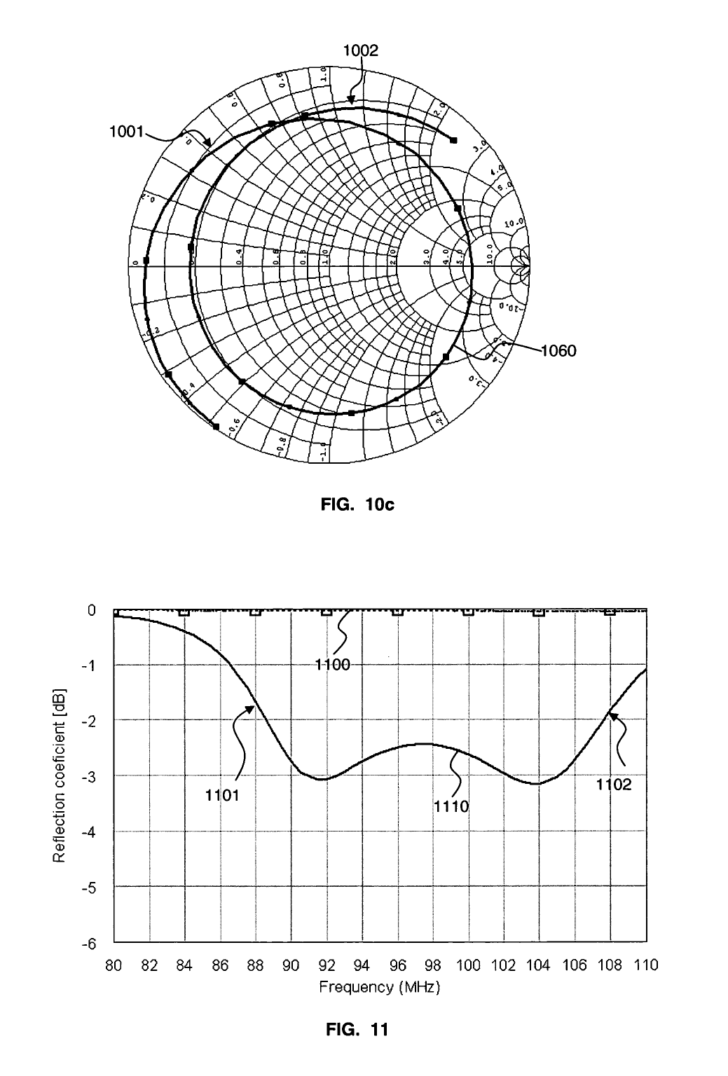

For example, in FIG. 10a curve 1000 represents on a Smith chart the typical complex impedance at said first internal port of the antenna structure 600 as a function of the frequency (before connecting to it a radiofrequency system). In particular, point 1001 corresponds to the input impedance at the lowest frequency of the second frequency region (i.e., 88 MHz), and point 1002 corresponds to the input impedance at the highest frequency of the second frequency region (i.e., 108 MHz).

Curve 1000 is located on the lower half of the Smith chart, which indeed confirms that the input impedance at the first internal port has a capacitive component (i.e., the imaginary part of the input impedance has a negative value) for at least all frequencies of the second frequency region (i.e., between point 1001 and point 1002).

FIG. 8 presents a schematic of a radiofrequency system 800 to be connected to the two internal ports of the antenna structure 600 in order to provide operability to the resulting antenna system in all the frequency regions of operation.

The radiofrequency system 800 comprises a first port 271 and a second port 272 to be connected respectively to the first and second external ports of the antenna system, and a third port 273 and a fourth port 274 to be connected respectively to the first and second internal ports of the antenna structure 600. The radiofrequency system 800 also comprises a frequency-selective circuit 810, 811, 812, 804 and a matching network 802, which provides impedance matching within the second frequency region.

The frequency-selective circuit includes a combiner/splitter 810 to combine (or split) the electrical signals of different frequency regions, a high-pass filter 811 and a low-pass filter 812. The high-pass filter 811 is operatively connected between the combiner/splitter 810 and the first port 271. The low-pass filter 812 is operatively connected between the combiner/splitter 810 and the matching network 802, which is connected to the second port 272. The combiner/splitter 810 is also connected to the third port 273.

The high-pass filter 811 is designed to present low insertion loss in the first and third frequency regions and high impedance in the second frequency region of operation of the antenna system. Analogously, the low-pass filter 812 is designed to present low insertion loss in said second frequency region and high impedance in said first and third frequency regions.

In some examples, the combiner/splitter 810 can be advantageously constructed by directly connecting in parallel the high-pass filter 811 and the low-pass filter 812 to the third port 273. This is possible because in the first and third frequency regions the low-pass filter 812 does not load the third port 273, while in the second frequency region the high-pass filter 811 does not load the third port 273.

The frequency-selective circuit additionally includes a frequency-selective load 804 connected to the fourth port 274.

For the frequencies of the first and third frequency regions, the frequency-selective circuit 810, 811, 812, 804 connects the third port 273 to the first port 271 and effectively short-circuits the fourth port 274.

Therefore, in the first and third frequency region, the radioelectric performance of this antenna system according to the present invention is equivalent to that of a conventional antenna system providing only the cellular communication standards. Thus, the reflection coefficient at the first external port of the antenna system according to the present invention would be similar to the one shown in FIG. 7.

For the frequencies of the second frequency region, the frequency-selective circuit 810, 811, 812, 804 connects the third port 273 to the second port 272 through the matching network 802 and loads with high-impedance the fourth port 274.

Therefore in the second frequency region, the impedance presented by the low-pass filter 812 to the matching network 802 is essentially the same as the input impedance at the first internal port of the antenna structure 600 when the radiofrequency system 800 is not connected to said antenna structure 600.

FIG. 9 is a schematic representation of the matching network 802, which comprises a first port 901 to be connected to the low-pass filter 812 of the radiofrequency system 800, and a second port 902 to be connected to the second port 272 of the radiofrequency system 800. In this example, the matching network 802 further comprises a reactance cancellation circuit 907 and a broadband matching circuit 908.

The reactance cancellation circuit 907 includes one stage comprising one single circuit component 904 arranged in series and featuring a substantially inductive behavior in the first, second and third frequency regions. In this particular example, the circuit component 904 is a lumped inductor. The inductive behavior of the reactance cancellation circuit 907 advantageously compensates the capacitive component of the input impedance of the first internal port of the antenna structure 600.

Such a reactance cancellation effect can be observed in FIG. 10b, in which the input impedance at the first internal port of the radiating structure 600, and presented to the first port 901 of the matching network 802, (curve 1000 in FIG. 10a) is transformed by the reactance cancellation circuit 907 into an impedance having an imaginary part substantially close to zero in the second frequency region (see FIG. 10b). Curve 1030 in FIG. 10b corresponds to the input impedance that would be observed at the second port 902 of the matching network 802 if the broadband matching circuit 908 were removed and said second port 902 were directly connected to a port 903. Said curve 1030 crosses the horizontal axis of the Smith Chart at a point 1031 located between point 1001 and point 1002, which means that the input impedance at the first internal port of the antenna structure 600 has an imaginary part equal to zero for a frequency advantageously between the lowest and highest frequencies of the second frequency region.

The broadband matching circuit 908 includes also one stage and is connected in cascade with the reactance cancellation circuit 907. Said stage of the broadband matching circuit 908 comprises two circuit components: a first circuit component 905 is a lumped inductor and a second circuit component 906 is a lumped capacitor. Together, the circuit components 905 and 906 form a parallel LC resonant circuit (i.e., said stage of the broadband matching circuit 908 behaves substantially as a resonant circuit in the second frequency region of operation).

Comparing FIGS. 10b and 10c, it is noticed that the broadband matching circuit 908 has the beneficial effect of “closing in” the ends of curve 1030 (i.e., transforming the curve 1030 into another curve 1060 featuring a more compact loop around the center of the Smith chart). Thus, the resulting curve 1060 exhibits an input impedance (now, measured at the second port 902) within a target voltage standing wave ratio (VSWR) over a broader range of frequencies.

Alternatively, the effect of the matching network of the radiofrequency system of FIG. 8 on the antenna structure of FIG. 6 can be compared in terms of the reflection coefficient. In FIG. 11 curve 1100 (in dashed line with square markers) presents the typical reflection coefficient of the antenna structure 600 observed at its first internal port when the radiofrequency system 800 is not connected to any of the internal ports of the antenna structure 600. From said curve 1100 it is clear that the antenna structure 600 is not matched in the second frequency region (the reflection coefficient is virtually 0 dB) and that the antenna element 601 is non-resonant in said second frequency region. On the other hand, curve 1110 (in solid line) corresponds to the reflection coefficient observed at the second external port of the antenna system resulting from the interconnection of the radiofrequency system 800 to the antenna structure 600.

The matching network 802 of the radiofrequency system 800 transforms the input impedance of the first internal port of the antenna structure 600 to provide impedance matching in the second frequency region. Curve 1110 is radically different from curve 1100. Indeed, curve 1110 exhibits a reflection coefficient better than −2 dB in practically the entire second frequency region (delimited by points 1101 and 1102 on the curve 1110), which makes it possible for the antenna system to operate the FM broadcast standard.

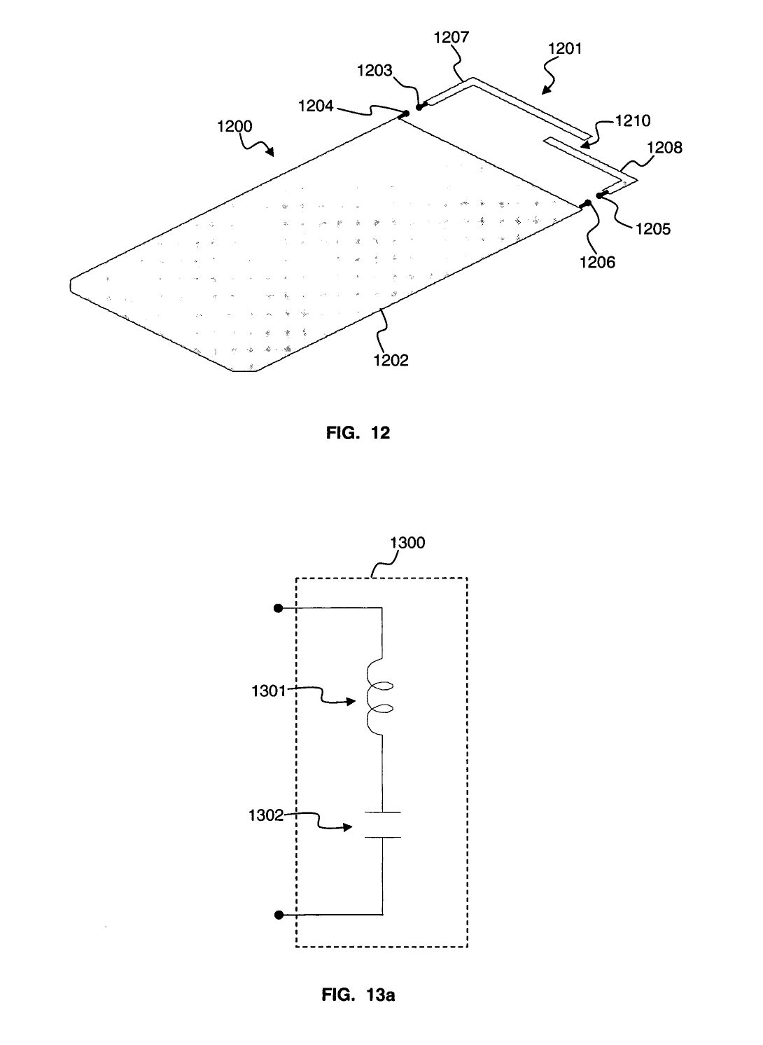

Referring now to FIG. 12, it is shown a perspective view of another example of an antenna structure for an antenna system capable of operating in a first region of the electromagnetic spectrum to provide one or more cellular communication standards, and in a second frequency region to provide one or more broadcast audio and/or video standards.

The antenna structure 1200 comprises an antenna element 1201 and a ground plane layer 1202. Differently from the previous example in FIG. 6, the antenna element 1201 includes now two separate conducting portions: a first conducting portion 1207 having an L-shaped geometry and comprising a first connection point 1203; and a second conducting portion 1208 having also an L-shaped geometry and comprising a second connection point 1205.

In the antenna structure 1200, the first conducting portion 1207 and the second conducting portion 1208 protrude beyond the ground plane layer 1202. That is, the conducting portions 1207, 1208 are arranged with respect to the ground plane layer 1202 in such a manner that there is no ground plane in the orthogonal projection of the antenna element 1201 onto the plane containing the ground plane layer 1202. Moreover, the first and second conducting portions 1207, 1208 are coplanar to the ground plane layer 1202.

Furthermore, said first and second conducting portions 1207, 1208 are arranged with respect to each other so as to create a close proximity region 1210 between an end of the first conducting portion 1207 and an end of the second conducting portion 1208. Said close proximity region 1210 advantageously couples electromagnetically the two conducting portions 1207, 1208.

In particular, said first and second conducting portions 1207, 1208 take the form of monopoles.

The ground plane layer 1202 has a substantially rectangular shape and comprises a first connection point 1204 located close to a first corner and a second connection point 1206 close to a second corner, said first and second corners being at opposite ends of an edge of the ground plane layer 1202.

A first internal port of the antenna structure 1200 is defined between the first connection point 1203 of the antenna element 1201 and the first connection point 1204 of the ground plane layer 1202. A second internal port of the antenna structure 1200 is defined between the second connection point 1205 of the antenna element 1201 and the second connection point 1206 of the ground plane layer 1202.

An antenna system capable of operation in the first and second frequency regions can be obtained by connecting any of two radiofrequency systems 270 shown in FIG. 4 to the antenna structure 1200.

At the frequencies of the first frequency region, the first internal port of the antenna structure 1200 is driven with electromagnetic wave signals coupled through a first external port of the antenna system, so that the first conducting portion 1207 acts as a driven element. At the same time, the second internal port of the antenna structure 1200 is effectively short-circuited, so that the second conducting portion 1208 acts as a parasitic element electromagnetically coupled to the first conducting portion 1207.

At the frequencies of the second frequency region, one of the two internal ports of the antenna structure 1200 is operatively connected to a second external port of the antenna system and one of the two conducting portions 1207, 1208 acts as a driven element for the reception of electromagnetic wave signals, while the other conducting portion is disabled.

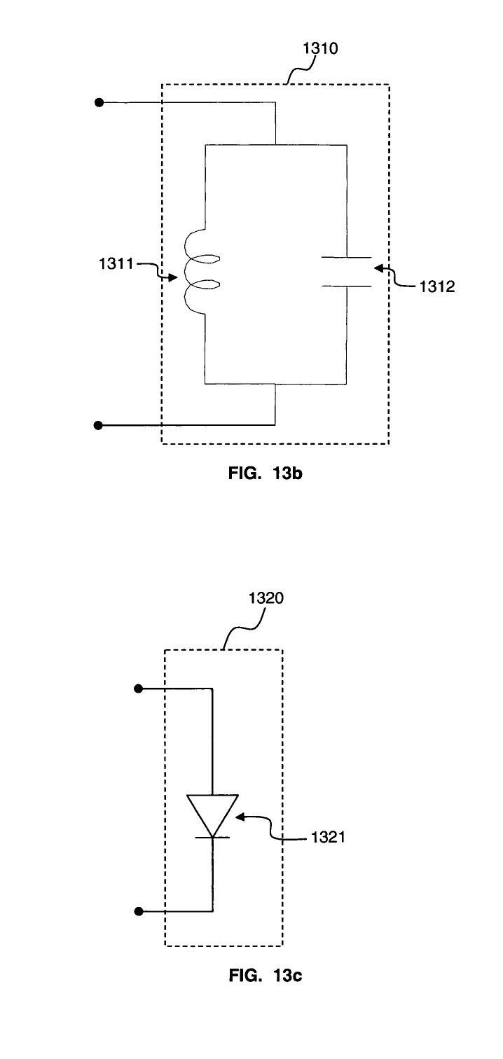

FIG. 13 shows, in the form of a schematic representation, three possible examples of a frequency-selective load suitable for a radiofrequency system such as those in FIGS. 4 and 8.

In general a frequency-selective load is designed to behave as an effective short-circuit for the frequencies of the first frequency region, but not for the frequencies of the second frequency region, and in particular feature a high impedance in said second frequency region of operation. Such a circuital behavior is obtained in any of the examples presented in FIG. 13.

In FIG. 13a, it is shown a frequency-selective load 1300 comprising one stage having two circuit components: a first circuit component is a lumped inductor 1301 and a second circuit component is a lumped capacitor 1302. Together, the inductor 1301 and the capacitor 1302 form a series LC resonant circuit that behaves substantially as a resonant circuit in the first frequency region of operation (i.e., the circuit becomes an effective short-circuit at resonance in the first frequency region, and features high impedance in the second frequency region).

FIG. 13b presents an alternative frequency-selective load 1310 comprising also one stage formed by a parallel connection between a lumped inductor 1311 and a lumped capacitor 1312, which form together a parallel LC resonant circuit. In this example, the parallel LC resonant circuit behaves substantially as a resonant circuit in the second frequency region of operation (i.e., the circuit features high impedance at resonance in the second frequency region, and becomes an effective short-circuit in the first frequency region).

Finally, in FIG. 13c it is shown one further example of a frequency-selective load 1320 of a different type. While in the two previous examples, the frequency-selective load 1300, 1310 comprises only passive circuit components, the frequency-selective load 1320 comprises an active circuit component, in particular a diode 1321 (such as for instance a PIN diode). The diode 1321 implements a switch having an “on” state and an “off” state. The frequency-selective load 1320 also includes adequate direct current (DC) feeding means (not shown in FIG. 13c) to properly bias the diode 1321 depending on the state of the switch. In the “on” state, the diode is forward biased and behaves as an effective short-circuit. On the other hand, in the “off” state the diode presents high impedance.

When the frequency-selective load 1320 is used in a radiofrequency system for an antenna system according the present invention, the diode 1321 must be in its “off” state in order to operate in the second frequency region. When operation in the first frequency region is required, the diode 1321 needs to be switched to its “on” state.

In other examples, the frequency-selective load 1320 may use as switch, instead of the diode 1321, a transistor or a MEMS device.

1. A wireless handheld or portable device including an antenna system (250) capable of operation in a first frequency region and in a second frequency region, wherein the highest frequency of the second frequency region is lower than the lowest frequency of the first frequency region, the antenna system (250) comprising an antenna structure (260) including:
an antenna element (251) having a first connection point (253a) and a second connection point (253b);
a ground plane layer (202) having at least one connection point (204);
a first internal port (261), said first port being defined between the first connection point (253a) of the antenna element (251) and one of the at least one connection point (204) of the ground plane layer (202); and
a second internal port (262), said second port (262) being defined between the second connection point (253b) of the antenna element (251) and one of the at least one connection point (204) of the ground plane layer (202);
the antenna system further comprising a first external port (231) for coupling electromagnetic wave signals in the first frequency region, a second external port (232) for coupling electromagnetic wave signals in the second frequency region, and a radiofrequency system (270) operatively connected between the first and second internal ports (261, 262) of the antenna structure (260) and the first and second external ports (231, 232) of the antenna system (250);
wherein the input impedance of the antenna structure (260) at each of the first and second internal ports (261, 262) when disconnected from the radiofrequency system (270) features an imaginary part not equal to zero for any frequency of the second frequency region, so that the antenna structure (260) is not resonant for any frequency of the second frequency region;
wherein the radiofrequency system (270) comprises a frequency-selective circuit (301) arranged so as to effectively short-circuit the second internal port (262) for the frequencies of the first frequency region but not for the frequencies of the second frequency region, to operatively connect the second external port (232) to one of the first and the second internal ports (261, 262) for the frequencies of the second frequency region but not for the frequencies of the first frequency region, and to operatively connect the first external port (231) to the first internal port (261) for the frequencies of the first frequency region.

2. The wireless handheld or portable device according to claim 1, wherein said frequency-selective circuit (301) is arranged so as to operatively connect the second external port (232) of the antenna system (250) to the first internal port (261) of the antenna structure (260) for the frequencies of the second frequency region but not for the frequencies of the first frequency region, and to effectively disconnect the first external port (231) of the antenna system (250) from the first internal port of the antenna structure (260) for the frequencies of the second frequency region.

3. The wireless handheld or portable device according to claim 1, wherein said frequency-selective circuit (301) is arranged so as to operatively connect the second external port of the antenna system (250) to the second internal port of the antenna structure (260) for the frequencies of the second frequency region but not for the frequencies of the first frequency region.

4. The wireless handheld or portable device according to claim 1, wherein, said frequency-selective circuit (301) is connected to said first and second internal ports (261, 262) of the antenna structure (260) and to the first external port (231) of the antenna system (250).

5. The wireless handheld or portable device according to claim 1, wherein the radiofrequency system (270) further comprises a matching network (302) to transform the input impedance of the antenna structure (260), providing impedance matching to the antenna system (250) in the second frequency region of operation of the antenna system (250), wherein said matching network (302) is operatively arranged between the frequency-selective circuit (301) and the second external port (232) of the antenna system (250).

6. The wireless handheld or portable device according to claim 1, wherein, the frequency-selective circuit (301) comprises
a diplexer to separate, or to combine, the electrical signals of the first and second frequency regions of operation of the antenna system (250), wherein the diplexer is operatively connected to the first and/or second internal port (261, 262) of the antenna structure (260).

7. The wireless handheld or portable device according to claim 1, wherein, the frequency-selective circuit comprises a bank of filters and a combiner/splitter, wherein the combiner/splitter combines or splits the electrical signals of the two frequency regions of operation of the antenna system (250),
wherein the bank of filters is a bank of two filters
wherein a first one of the two filters is a band-pass filter or, alternatively, a high-pass filter, which is designed to introduce low insertion loss in the first frequency region and to present high impedance to the combiner/splitter in the second frequency region and
wherein a second filter of the two filters is band-pass filter or, alternatively, a low-pass filter, which is designed to introduce low insertion loss in the second frequency region and to present high impedance to the combiner/splitter in the first frequency region,
wherein high impedance in a given frequency region refers to an impedance having a modulus not smaller than 300 Ohms for any frequency within said frequency region, and/or being substantially reactive (i.e., having a real part substantially close to zero) within said given frequency region, wherein the bank of filters and the combiner/splitter is operatively connected to the first and/or second internal port (261, 262) of the antenna structure (260).

8. The wireless handheld or portable device according to claim 1, wherein, the frequency-selective circuit (301) includes a frequency-selective load (404, 804) comprising at least one stage operatively connected to the second internal port (262) of the antenna structure (260) designed to present high impedance to said second internal port (262) in the second frequency region and to present low impedance to said second internal port (262) in the first frequency region, so as to effectively short-circuit it,
wherein high impedance in a given frequency region refers to an impedance having a modulus not smaller than 300 Ohms for any frequency within said frequency region, and optionally being substantially reactive i.e., having a real part substantially close to zero within said given frequency region,
wherein low impedance or the effective short-circuit condition in a given frequency range refers to an impedance presented to said second internal port having a modulus not larger than 20 Ohms for any frequency within said frequency region, and optionally being substantially reactive, i.e., having a real part substantially close to zero.

9. The wireless handheld or portable device according to claim 8, wherein, said frequency-selective load (454) is operatively connected to the second internal port (262) of the antenna structure (260) through a diplexer or through a bank of filters.

10. The wireless handheld or portable device according to claim 8, wherein, said frequency-selective load (404, 804) is connected directly to the second internal (262) port of the antenna structure (260).

11. The wireless handheld or portable device according to claim 9, wherein the frequency-selective load (1300) comprises one stage having a lumped inductor (1301) and a lumped capacitor (1302) forming a series LC resonant circuit that behaves substantially as a resonant circuit in the first frequency region of operation.

12. The wireless handheld or portable device according to claim 9, wherein the frequency-selective load (1310) comprises a parallel connection between a lumped inductor (1311) and a lumped capacitor (1312), forming together a parallel LC resonant circuit which behaves substantially as a resonant circuit in the second frequency region of operation.

13. The wireless handheld or portable device according to claim 9, wherein the frequency-selective load (1320) comprises a diode (1321) implementing a switch having an “on” state and an “off” state and direct current (DC) feeding means to properly bias the diode depending on the state of the switch.

14. The wireless handheld or portable device according to claim 5, wherein the matching network (302, 500) includes a reactance cancellation circuit (503) comprising one or more stages, with one of said one or more stages being connected, through the frequency-selective circuit (301), to an internal port (261, 262) of the antenna structure (260),
wherein a reactance cancellation refers to compensating the imaginary part of the input impedance at an internal port of the antenna structure (260) when disconnected from the radiofrequency system such that for example the input impedance of the antenna system (250) at the second external port (232) has an imaginary part substantially close to zero for a frequency optionally within the second frequency region of operation, wherein the imaginary part of an impedance is considered to be substantially close to zero if it is not larger in absolute value than 10 Ohms.

15. The wireless handheld or portable device according claim 1, wherein the antenna structure (260) features at an internal port (261, 262) when the radiofrequency system (270) is disconnected from said internal port (261, 262) an input impedance having a capacitive component for the frequencies of the second frequency region of operation, and
a matching network (302, 500) operatively connected to said internal port (261, 262) via the frequency-selective circuit (301) includes a reactance cancellation circuit (503) that comprises a first stage having a substantially inductive behavior for all the frequencies of the second frequency region of operation of the antenna system (250), wherein preferably, said first stage comprises an inductor, wherein said first stage is connected, through the frequency-selective circuit (301), in series with said internal port (261, 262) of the antenna structure (260).

16. The wireless handheld or portable device according to claim 1, wherein the antenna structure (260) features at an internal port (261, 262) when the radiofrequency system (270) is disconnected from said internal port (261, 262) an input impedance having an inductive component for the frequencies of the second frequency region of operation and,
a matching network (302, 500) operatively connected to said internal port (261, 262) via the frequency-selective circuit (301) includes a reactance cancellation circuit (503) that comprises a first stage and a second stage forming an L-shaped structure, with said first stage being connected in parallel and said second stage being connected in series, wherein each of the first and the second stage has a substantially capacitive behavior for all the frequencies of the second frequency region of operation of the antenna system (250), wherein optionally said first stage and said second stage comprise each a capacitor, wherein said first stage is connected, through the frequency-selective circuit (301), in parallel with said internal port (261, 262) of the antenna structure (260), while said second stage is connected to said first stage.

17. The wireless handheld or portable device according to claim 5, wherein, the matching network (302, 500) comprises a broadband matching circuit (530), said broadband matching circuit (530) being connected in cascade to the reactance cancellation circuit (503), wherein the broadband matching circuit (530) comprises a stage that substantially behaves as a resonant circuit, such as a parallel LC resonant circuit or as a series LC resonant circuit, in the second frequency region of operation of the antenna system (250).

18. The wireless handheld or portable device according to claim 14, wherein the matching network (302, 500) further comprises, in addition to the reactance cancellation circuit (503) and/or the broadband matching circuit (530), another circuit such as a fine tuning circuit (560) to correct small deviations of the input impedance of the antenna system (250) with respect to some given target specifications.

19. The wireless handheld or portable device according to claim 5, wherein, a matching network (302, 500) comprises: a reactance cancellation circuit (503) connected to the frequency selective circuit (301) and another circuit, such as a fine tuning circuit (560), connected to the second external port (232) of the antenna system (250), wherein said matching network (302, 500) further comprises a broadband matching circuit (530) operatively connected in cascade between the reactance cancellation circuit (503) and the another circuit.

20. The wireless handheld or portable device according to claim 1, wherein said frequency-selective circuit (301) loads the second internal port (262) of the antenna structure (260) with high impedance for frequencies of the second frequency region,
wherein high impedance in a given frequency region refers to an impedance having a modulus not smaller than 300 Ohms for any frequency within said frequency region, and optionally being substantially reactive i.e., having a real part substantially close to zero within said given frequency region, and wherein said radiofrequency system modifies the impedance of the antenna structure (260), providing impedance matching to the antenna system (250) in the second frequency region of operation.

21. The wireless handheld or portable device according to claim 1, wherein, the antenna element (601) comprises a single conducting portion including the first and the second connection points (603, 605), wherein optionally said single conducting portion is the antenna element of a planar inverted-F antenna (PIFA) or an inverted-F antenna (IFA).

22. The wireless handheld or portable device according to claim 1, wherein, the antenna element (1201) comprises two separate conducting portions (1207, 1208): a first portion (1207) including the first connection point (1203) of the antenna element (1201), and a second portion (1208) including the second connection point (1205) of the antenna element (1201), wherein said first and second conducting portions (1207, 1208) are arranged with respect to each other such that the two conducting portions (1207, 1208) are electromagnetically coupled either capacitively or inductively to each other by means of a close proximity region and, wherein optionally said first and second conducting portions (1207, 1208) take the form of monopoles.

23. The wireless handheld or portable device according to claim 1, wherein it is adapted to operate one or more cellular communication standards and/or wireless connectivity standards, each standard being allocated in one or more frequency bands, and said frequency bands being contained within said first frequency region of the electromagnetic spectrum and the wireless handheld or portable device is adapted to operate one or more broadcast audio and/or video standards, each standard being allocated in one or more frequency bands, and said frequency bands being contained within said second frequency region of the electromagnetic spectrum wherein, the first frequency region is located completely above 800 MHz and the second frequency region is located completely below 800 MHz.

24. The wireless handheld or portable device according to claim 1, wherein the antenna structure (260) features at each internal port e.g., at the first and second internal ports (261, 262), when disconnected from the radiofrequency system (270), a first resonance frequency located above i.e., higher than the second frequency region of operation of the antenna system (250), wherein, the ratio between the first resonance frequency at a given internal port of the antenna structure (260) when disconnected from the radiofrequency system (270) and the highest frequency of the second frequency region is larger than a minimum ratio of 7.8 and less than a maximum ratio of 9.0.

25. A method to provide operability in a second frequency region to an existing antenna system (250) of a wireless handheld or portable device already operating in a first frequency region, said second frequency region having a highest frequency lower than a lowest frequency of said first frequency region, the antenna system (250) comprising an antenna structure (260) including:
an antenna element (251) having a first connection point (253a) and a second connection point (253b);
a ground plane layer (202) having at least one connection point (204);
a first internal port (261), said first port being defined between the first connection point (253a) of the antenna element (251) and one of the at least one connection point (204) of the ground plane layer (202); and
a second internal port (262), said second port being defined between the second connection point (253b) of the antenna element (251) and one of the at least one connection point (204) of the ground plane layer (202);
the antenna system (250) further comprising a first external port (231) for coupling electromagnetic wave signals in the first frequency region, the first external port (231) being operatively connected to the first internal port (261);
the second connection point (253b) of the antenna element (251) being connected to the connection point (204) of the ground plane layer (202) used for defining the second internal port (262), such that the second internal port (262) is effectively short-circuited;
wherein the input impedance at the first internal port (261) of the antenna structure (260) before being connected to the first external port (231) features an imaginary part not equal to zero for any frequency of the second frequency region and the input impedance at the second internal port of the antenna structure (260) before being effectively short-circuited features an imaginary part not equal to zero for any frequency of the second frequency region, so that the antenna structure (260) is not resonant for any frequency of the second frequency region;
the method comprising the steps of:
disconnecting the first external port (231) from the first internal port (261);
removing the connection between the second connection point (253b) of the antenna element (251) and the connection point (204) of the ground plane layer (202) used for defining the second internal port (262);
providing a second external port (232) to the antenna system (250) for coupling electromagnetic wave signals in the second frequency region; and
providing a radiofrequency system (270) to the antenna system (250), the radiofrequency system being operatively connected between the first and the second internal ports (261, 262) of the antenna structure (260) and the first and second external ports (231, 232) of the antenna system (250);
wherein the radiofrequency system comprises a frequency-selective circuit (301) arranged so as to effectively short-circuit the second internal port (262) for the frequencies of the first frequency region but not for the frequencies of the second frequency region, to operatively connect the second external port (232) to one of the first and the second internal ports (261, 262) for the frequencies of the second frequency region but not for the frequencies of the first frequency region, and to operatively connect the first external port (231) to the first internal port (261) for the frequencies of the first frequency region, such that the resulting antenna system (250) can operate in the second frequency region in addition to maintaining its operation in the first frequency region.

26. The method of claim 25, wherein the frequency-selective circuit (301) loads the second internal port of the antenna structure (260) with high impedance for the frequencies of the second frequency region wherein high impedance in a given frequency region refers to an impedance having a modulus not smaller than 300 Ohms for any frequency within said frequency region, and optionally being substantially reactive i.e., having a real part substantially close to zero within said given frequency region.

27. A wireless handheld or portable device including an antenna system (200) capable of operation in a first frequency region and in a second frequency region, wherein the highest frequency of the second frequency region is lower than the lowest frequency of the first frequency region, the antenna system (200) comprising an antenna structure (210) including:
an antenna element (201) having a connection point (203);
a ground plane layer (202) having at least one connection point (204);
an internal port (211), said internal port (211) being defined between the connection point (203) of the antenna element and one of the at least one connection point (204) of the ground plane layer (202);
the antenna system (200) further comprising a first external port (231) for coupling electromagnetic wave signals in the first frequency region, a second external port (232) for coupling electromagnetic wave signals in the second frequency region, and a radiofrequency system (220) operatively connected between the internal port (211) of the antenna structure (210) and the first and second external ports (231, 232) of the antenna system (200);
wherein the input impedance of the antenna structure (210) at the internal port (211) when disconnected from the radiofrequency system (220) features an imaginary part not equal to zero for any frequency of the second frequency region, so that the antenna structure (210) is not resonant for any frequency of the second frequency region;
wherein the radiofrequency system (220) comprises a frequency-selective circuit arranged so as to operatively connect the second external port (232) to the internal port (211) for the frequencies of the second frequency region but not for the frequencies of the first frequency region, and to operatively connect the first external port (231) to the internal port (211) for the frequencies of the first frequency region but not for the frequencies of the second region.

28. A method to provide operability in a second frequency region to an existing antenna system (200) of a wireless handheld or portable device already operating in a first frequency region, said second frequency region having a highest frequency lower than a lowest frequency of said first frequency region, the antenna system (200) comprising an antenna structure (210) including:
an antenna element (201) having a connection point (203);
a ground plane layer (202) having at least one connection point (204);
an internal port (211), said internal port (211) being defined between the connection point (203) of the antenna element (201) and one of the at least one connection point (204) of the ground plane layer (202);
the antenna system (200) further comprising a first external port (231) for coupling electromagnetic wave signals in the first frequency region, the first external port (231) being operatively connected to the internal port (211);
wherein the input impedance at the internal port (211) of the antenna structure (210) before being connected to the first external port (231) features an imaginary part not equal to zero for any frequency of the second frequency region so that the antenna structure (210) is not resonant for any frequency of the second frequency region;
the method comprising the steps of:
disconnecting the first external port (231) from the internal port (211);
providing a second external port (232) to the antenna system (200) for coupling electromagnetic wave signals in the second frequency region; and
providing a radiofrequency system (220) to the antenna system (200), the radiofrequency system being operatively connected between the internal port (211) of the antenna structure (210) and the first and second external ports (231, 232) of the antenna system (200);
wherein the radiofrequency system (220) comprises a frequency-selective circuit arranged so as to operatively connect the second external port (232) to the internal port (211) for the frequencies of the second frequency region but not for the frequencies of the first frequency region, and to operatively connect the first external port (231) to the internal port (211) for the frequencies of the first frequency region, such that the resulting antenna system (200) can operate in the second frequency region in addition to maintaining its operation in the first frequency region.
